(19) United States
(12) Patent Application Publication
(10) Pub. No.: US 2002/0151451 A1
(43) Pub. Date: Oct. 17, 2002

(54) Compositions comprising XET and a polysaccharide and/or oligosaccharide

(75) Inventors: Mary Vijayarani Barnabas, West Chester, OH (US); Kotikanyadanam Sreekrishna, Cincinnati, OH (US); Johan Smets, Lubbeek (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/056,169

(22) Filed: Jan. 24, 2002

Related U.S. Application Data
(60) Provisional application No. 60/145,902, filed on Jul. 27, 1999.

(30) Foreign Application Priority Data
Jul. 26, 2000 (US) PCT/US00/20329

(51) Int. Cl. C11D 3/386; D06L 1/00

(52) U.S. Cl. 510/392; 510/470; 510/305; 510/320; 510/530

(57) ABSTRACT

The present invention relates to laundry and/or fabric and/or color care compositions; more particularly, to laundry and/or fabric and/or color care compositions containing xyloglucan endotransglycosylase enzyme (XET) in combination with a polysaccharide and/or oligosaccharide, preferably a xyloglucan polymer, that provide improved anti-wrinkle and/or shape retention and/or anti-shrinkage and/or tensile strength and/or color appearance and/or anti-bobbling and/or better static control, fabric softness, anti-wear properties and benefits, while at the same time providing improved cleaning benefits, over laundry and/or fabric and/or color care compositions without such combination of XET and polysaccharide and/or oligosaccharide.

### TECHNICAL FIELD OF THE INVENTION

The present invention relates to laundry and/or fabric and/or color care compositions; more particularly, to laundry and/or fabric and/or color care compositions containing xyloglucan endotransglycosylase enzyme (XET) in combination with a polysaccharide and/or oligosaccharide, preferably a xyloglucan polymer, that provide improved anti-wrinkle and/or shape retention and/or anti-shrinkage and/or tensile strength and/or color appearance and/or anti-bobbling and/or better static control, fabric softness, anti-wear properties and benefits, while at the same time providing improved cleaning benefits, over laundry and/or fabric and/or color care compositions without such combination of XET and polysaccharide and/or oligosaccharide.

### BACKGROUND OF THE PRESENT INVENTION

In recent years, consumer desirability for fabric conditioning compositions has risen. Fabric softening compositions impart several desirable properties to treated garments including softness and static control. Fabric softness of laundered garments is typically achieved by delivering a quaternary ammonium compound to the surface of the fabric.

Consumer desirability for durable press fabric garments, particularly cotton fabric garments, has also risen. Durable press garments include those garments which resist wrinkling of the fabric both during wear and during the laundering process. Durable press garments can greatly decrease the hand work associated with laundering by eliminating ironing or reducing ironing time sometimes necessary to prevent wrinkling of the garment. However, in most commercially available durable press fabrics, the fabric's ability to resist wrinkling is reduced over time as the garment is repeatedly worn and laundered.

Further, colored garments have a tendency to wear and show appearance losses. A portion of this color loss may be attributed to abrasion in the laundering process, particularly in automatic washing machines and automatic laundry dryers.

Moreover, tensile strength loss of fabric appears as an unavoidable result of mechanical/chemical action due to use/wearing or washing.

As indicated above, there is a continuous need for a laundry detergent and/or fabric care composition which provides excellent fabric cleaning and/or fabric stain removal, especially on body soils and plant based stains and/or fabric whiteness maintenance and/or fabric color appearance and/or dye transfer inhibition.

In addition, there is a continuous need for a laundry detergent composition and/or fabric care composition, which can provide, refurbish, restore and/or improve tensile strength, anti-wrinkle, anti-bobbling and/or anti-shrinkage properties of fabrics, as well as provide static control, fabric softness, color appearance and/or fabric anti-wear properties and benefits.

A prior art attempt at fulfilling this need is described in WO 97/23683, published Jul. 3, 1997 to Novo. WO 97/23683 discloses a process for providing a cellulosic material, such as a fabric or a paper and pulp product, with improved strength and/or shape retention and/or anti-wrinkling properties, by using xyloglucan endotransglycosylase (XET). Among other things, this reference fails to teach or suggest using the XET in combination with a polysaccharide and/or oligosaccharide such as xyloglucan polymer in a laundry and/or fabric care composition.

WO 98/49387 published Nov. 5, 1998 to Novo discloses a method of manufacturing a fabric or a garment with a stone-washed or worn look. The method discloses the use of xyloglucan and xyloglucanase. Among other things, this reference fails to teach or suggest using the XET in combination with a polysaccharide and/or oligosaccharide such as xyloglucan polymer in a fabric care composition.

WO 98/38288 published Sep. 3, 1998 to Novo discloses a method for the production of xyloglucan endotransglycosylase enzyme (XET) comprising culturing in a suitable nutrient medium a microorganism expressing a microbial XET under conditions conducive to the production of the XET enzyme. Among other things, this reference fails to teach or suggest using the XET in combination with a polysaccharide and/or oligosaccharide such as xyloglucan polymer in a fabric care composition.

It is a further object of the present invention to provide detergent compositions and/or fabric care compositions comprising XET in combination with a polysaccharide and/or oligosaccharide, which can provide, refurbish and/or restore improved tensile strength, enhanced anti-wrinkle, anti-bobbling and anti-shrinkage properties to fabrics, as well as provide better static control, fabric softness, color appearance and fabric anti-wear properties and benefits, while providing improved cleaning benefits.

### SUMMARY OF THE INVENTION

The present invention is a laundry and/or fabric care composition comprising a combination of a XET enzyme and a polysaccharide and/or oligosaccharide, methods of using the composition to provide, refurbish, restore and/or improve tensile strength, anti-wrinkle, anti-bobbling and/or anti-shrinkage properties to fabrics, as well as provide better static control, fabric softness, color appearance and/or fabric anti-wear properties and benefits, while at the same time providing improved cleaning benefits.

In accordance with one aspect of the present invention, a laundry and/or fabric care composition comprising a combination of a XET enzyme and a polysaccharide and/or oligosaccharide, and optionally cleaning adjunct materials including, but not limited to, bleaching agents, enzymes, preferably cellulase, surfactants, chelating agents and builders, is provided.

In accordance with another aspect of the present invention, a method for treating a fabric in need of treatment comprising contacting the fabric with an effective amount of a laundry and/or fabric care composition comprising a combination of a XET enzyme and a polysaccharide and/or oligosaccharide, and optionally cleaning adjunct materials including, but not limited to, bleaching agents, enzymes, preferably cellulase, surfactants, chelating agents and builders, such that the composition treats the fabric is provided.

In accordance with yet another aspect of the present invention, a method for treating a fabric in need of treatment with a laundry and/or fabric care composition comprising a combination of a XET enzyme and a polysaccharide and/or oligosaccharide, and optionally cleaning adjunct materials including, but not limited to, bleaching agents, enzymes, preferably cellulase, surfactants, chelating agents and builders, is provided. This method is useful under normal home laundering conditions, either with an automatic washing machine or by hand washing. However, it is especially useful under automatic washing machine conditions.

In accordance with still yet another aspect of the present invention, a method for treating a fabric in need of treatment with a laundry and/or fabric care composition comprising a combination of a XET enzyme and a polysaccharide and/or oligosaccharide, and optionally cleaning adjunct materials including, but not limited to, bleaching agents, enzymes, preferably cellulase, surfactants, chelating agents and builders, is provided.

In accordance with still yet another aspect of the present invention, a method for treating a fabric in need of treatment with a laundry and/or fabric care composition comprising a combination of a XET enzyme and a polysaccharide and/or oligosaccharide, and optionally cleaning adjunct materials including, but not limited to, bleaching agents, enzymes, preferably cellulase, surfactants, chelating agents and builders, by soaking the fabric in the composition is provided.

A preferred laundry and/or fabric care composition in accordance with the present invention comprises a combination of a XET enzyme and a polysaccharide and/or oligosaccharide and one or more cleaning adjunct materials (i.e., detergent ingredients, preferably preferred ingredients as described herein). Preferably, the laundry and/or fabric care composition of the present invention is in the form of an aqueous or non-aqueous heavy duty liquid detergent composition or a rinse-aid composition. However, the laundry and/or fabric care composition may be in the form of a liquid for spray application, or a solid, such as a concentrated stick, for rubbing onto the fabric.

All percentages and proportions herein are by weight, and all references cited herein are hereby incorporated by reference, unless otherwise specifically indicated.

### DETAILED DESCRIPTION OF THE INVENTION

Definitions

The laundry and/or fabric care compositions of the present invention comprise an “effective amount” of a combination of a XET enzyme and a polysaccharide and/or oligosaccharide. An “effective amount” of a combination of a XET enzyme and a polysaccharide and/or oligosaccharide is any amount capable of measurably improving the anti-wrinkle and/or shape retention and/or anti-shrinkage and/or tensile strength and/or color appearance and/or anti-bobbling and/or better static control, fabric softness, anti-wear properties of a fabric, i.e., cotton, when it is washed in a washing machine, sprayed onto the fabric, rubbed onto the fabric, hand-washed or soaked by a consumer. In general, this amount may vary quite widely. Therefore, an “effective amount” of the laundry and/or fabric care compositions of the present invention means an amount capable of measurably improving the anti-wrinkle and/or shape retention and/or anti-shrinkage and/or tensile strength and/or color appearance and/or anti-bobbling and/or better static control, fabric softness, anti-wear properties of a fabric, i.e., cotton, when it is washed in a washing machine, sprayed onto the fabric, rubbed onto the fabric, hand-washed or soaked by a consumer.

“Fabric care composition(s)” herein is meant to encompass generally fabric care compositions and/or fabric conditioners.

“Fabric” herein is meant to encompass cellulosic fibers/fabrics, cotton blends, rayon, ramie, jute, flax, linen, polynosic-fibers, Lyocell (Tencel®), poly/cotton, other cotton blends and the like, and mixtures thereof.

“Fabric in need of treatment” herein is meant to encompass any fabrics in accordance with the present invention, preferably fabrics that have not previously been treated with the laundry and/or fabric care compositions, both new and old fabrics, as well as fabrics which are exhibiting reduced or loss of anti-wrinkle and/or shape retention and/or anti-shrinkage and/or tensile strength and/or color appearance and/or anti-bobbling and/or better static control, fabric softness, anti-wear properties, and soiled fabrics

It has been surprisingly found that the laundry and/or fabric care compositions of the present invention comprising a combination of a XET enzyme and a polysaccharide and/or oligosaccharide impart to a fabric in need of treatment improved anti-wrinkle and/or shape retention and/or anti-shrinkage and/or tensile strength and/or color appearance and/or anti-bobbling and/or better static control, fabric softness, anti-wear properties and benefits, while at the same time providing improved cleaning benefits. These benefits provided by the compositions of the present invention improve the appearance and/or wear of the fabric.

XET

XET for use in the present invention can be obtained from any suitable source known to those skilled in the art.

Suitable sources of XET for use in the present invention include, but are not limited to, plants, in particular land plants as described in WO 97/23683 to Novo. XET can be extracted from cotyledons from the family Fabaceae (synonyms: Leguminosae and Papilionaceae), preferably genera Phaseolus, in particular, Phaseolus aureus. Such cotyledons include, but are not limited to, dicotyledons and monocotyledons. Preferred monocotyledons are graminaceous monocotyledons and liliaceous monocotyledons. XET can also be extracted from moss and liverwort, as described in Biochem. J. 282, 823 (1992).

Suitable methods for extracting XET from plants are described in Biochem. J. 282, 821-828 (1992), an article entitled “Xyloglucan endotransglycosylase: evidence for the existence of a relatively stably glycosyl-enzyme intermediate”, Z. Sulova, M. Takacova, N. M. Steele, S C. Fry, and V. Farkas, Biochem. J. 330, 1475-1480 (1998), and an article entitled “A Colorimetric Assay for Xyloglucan-Endotransglycosylase from Germinating Seeds”, Z. Sulova, M. Lednicka, and V. Farkas, Anal. Biochem. 229, 80-85 (1995).

Additional suitable sources of XET include microorganisms including, but not limited to, Aspergillus oryzae and Aspergillus niger as described in WO 97/23683 and WO 98/38288 both to Novo. Suitable methods for cultivating XET from microorganisms is described in EP 562 836.

Polysaccharides

“Polysaccharides” herein is meant natural polysaccharides, and does not include polysaccharide derivatives or modified polysaccharides. Suitable polysaccharides for use in the treating compositions of the present invention include, but are not limited to, gums, arabinans, galactans, seeds and mixtures thereof.

Suitable polysaccharides that are useful in the present invention include polysaccharides with a degree of polymerization (DP) over 40, preferably from about 50 to about 100,000, more preferably from about 500 to about 50,000, constituting saccharides preferably include, but are not limited to, one or more of the following saccharides: isomaltose, isomaltotriose, isomaltotetraose, isomaltooligosaccharide, fructooligosaccharide, levooligosaccharides, galactooligosaccharide, xylooligosaccharide, gentiooligosaccharides, disaccharides, glucose, fructose, galactose, xylose, mannose, sorbose, arabinose, rhamnose, fucose, maltose, sucrose, lactose, maltulose, ribose, lyxose, allose, altrose, gulose, idose, talose, trehalose, nigerose, kojibiose, lactulose, oligosaccharides, maltooligosaccharides, trisaccharides, tetrasaccharides, pentasaccharides, hexasaccharides, oligosaccharides from partial hydrolysates of natural polysaccharide sources and mixtures thereof.

The polysaccharides can be extracted from plants, produced by organisms, such as bacteria, fungi, prokaryotes, eukaryotes, extracted from animals and/or humans. For example, xanthan gum can be produced by Xanthomonas campestris, gellan by Sphingomonas paucimobilis, xyloglucan can be extracted from tamarind seed.

The polysaccharides can be linear, or branched in a variety of ways, such as 1-2, 1-3, 104, 1-6, 2-3 and mixtures thereof.

It is desirable that the polysaccharides of the present invention have a molecular weight in the range of from about 10,000 to about 10,000,000, more preferably from about 50,000 to about 1,000,000, most preferably from about 50,000 to about 500,000.

Preferably, the polysaccharide is selected from the group consisting of: tamarind gum (preferably consisting of xyloglucan polymers), guar gum, locust bean gum (preferably consisting of galactomannan polymers), and other industrial gums and polymers, which include, but are not limited to, Tara, Fenugreek, Aloe, Chia, Flaxseed, Psyllium seed, quince seed, xanthan, gellan, welan, rhamsan, dextran, curdlan, pullulan, scleroglucan, schizophyllan, chitin, hydroxyalkyl cellulose, arabinan (preferably from sugar beets), de-branched arabinan (preferably from sugar beets), arabinoxylan (preferably from rye and wheat flour), galactan (preferably from lupin and potatoes), pectic galactan (preferably from potatoes), galactomannan (preferably from carob, and including both low and high viscosities), glucomannan, lichenan (preferably from icelandic moss), mannan (preferably from ivory nuts), pachyman, rhamnogalacturonan, acacia gum, agar, alginates, carrageenan, chitosan, clavan, hyaluronic acid, heparin, inulin, cellodextrins, and mixtures thereof. These polysaccharides can also be treated (preferably enzymatically) so that the best fractions of the polysaccharides are isolated.

More preferred polysaccharides have a β-linked backbone.

Xyloglucan polymer is a highly preferred polysaccharide for use in the laundry and/or fabric care compositions of the present invention. Xyloglucan polymer is preferably obtained from tamarind seed polysaccharides. The preferred range of molecular weights for the xyloglucan polymer is from about 10,000 to about 1,000,000, more preferably from about 50,000 to about 200,000.

Polysaccharides, when present, are normally incorporated in the treating composition of the present invention at levels from about 0.1% to about 25%, preferably from about 0.2% to about 10% by weight of the treating composition.

Polysaccharides have a high affinity for binding with cellulose. Without wishing to be bound by theory, it is believed that the binding efficacy of the polysaccharides to cellulose depends on the type of linkage, extent of branching and molecular weight. The extent of binding also depends on the nature of the cellulose (i.e., the ratio of crystalline to amorphous regions in cotton, rayon, linen, etc.).

The natural polysaccharides can be modified with amines (primary, secondary, tertiary), amides, esters, ethers, alcohols, carboxylic acids, tosylates, sulfonates, sulfates, nitrates, phosphates and mixtures thereof. Such a modification can take place in position 2, 3 and/or 6 of the glucose unit. Such modified or derivatized polysaccharides can be included in the compositions of the present invention in addition to the natural polysaccharides.

Nonlimiting examples of such modified polysaccharides include: carboxyl and hydroxymethyl substitutions (e.g., glucuronic acid instead of glucose); amino polysaccharides (amine substitution, e.g., glucosamine instead of glucose); C₁-C₆ alkylated polysaccharides; acetylated polysaccharide ethers; polysaccharides having amino acid residues attached (small fragments of glycoprotein); polysaccharides containing silicone moieties. Suitable examples of such modified polysaccharides are commercially available from Carbomer and include, but are not limited to, amino alginates, such as hexanediamine alginate, amine functionalized cellulose-like O-methyl-(N-1,12-dodecanediamine) cellulose, biotin heparin, carboxymethylated dextran, guar polycarboxylic acid, carboxymethylated locust bean gum, carboxymethylated xanthan, chitosan phosphate, chitosan phosphate sulfate, diethylaminoethyl dextran, dodecylamide alginate, sialic acid, glucuronic acid, galacturonic acid, mannuronic acid, guluronic acid, N-acetylglucosamine, N-acetylgalactosamine, and mixtures thereof.

The polysaccharide polymers can be linear, like in hydroxyalkylcellulose, the polymer can have an alternating repeat like in carrageenan, the polymer can have an interrupted repeat like in pectin, the polymer can be a block copolymer like in alginate, the polymer can be branched like in dextran, the polymer can have a complex repeat like in xanthan. Descriptions of the polymer definitions are give in “An introduction to Polysaccharide Biotechnology”, by M> Tombs and S. E. Harding, T. J. Press 1998.

Oligosaccharides

The compositions of the present invention may include oligosaccharides. Suitable oligosaccharides that are useful in the present invention include oligosaccharides with a degree of polymerization (DP) of less than 20, preferably from about 1 to about 15, more preferably from about 2 to about 10, constituting monosaccharides preferably include, but are not limited to, one or more of the following monosaccharides: glucose, fructose, galactose, xylose, mannose, arabinose, rhamnose, ribose, lyxose, allose, altrose, gulose, idose, talose, and/or their derivatives. Preferred oligosaccharides have a molecular weight in the range of from about 300 to about 8000. Branched oligosaccharides are preferred over linear oligosaccharides.

Nonlimiting examples of suitable oligosaccharides can be obtained commercially from any of the suppliers—Carbomer (fructo-oligosaccharides, levo-oligosaccharides, inulin, dextra 5000, cellosaccharides, etc.,), Grain Processing Corporation (maltodextrin), Pharmacica Biotech (Dextran series), Palatinit (isomalt) and Showa Sangyo (Isomalto-500).

Cyclic oligosaccharides can also be useful in the fabric care composition of the present invention. Preferred cyclic oligosaccharides include α-cyclodextrin, β-cyclodextrin, γ-cyclodextrin, their branched derivatives such as glucosyl-α-cyclodextrin, diglucosyl-α-cyclodextrin, maltosyl-α-cyclodextrin, glucosyl-β-cyclodextrin, diglucosyl-β-cyclodextrin, and mixtures thereof. The cyclodextrins also provide an optional but very important benefit of odor control, and are disclosed more fully hereinbelow.

Oligosaccharides, when present, are normally incorporated in the cleaning composition at levels from about 1% to about 25%, preferably from about 2% to about 10% by weight of the laundry and/or fabric care composition.

Preferred Cleaning Adjunct Materials

The laundry and/or fabric care compositions of the present invention preferably comprise an effective amount of a combination of a XET enzyme and a polysaccharide and/or oligosaccharide and one or more of the following preferred cleaning adjunct materials selected from the group consisting of bleach systems comprising bleaching agents, celluase enzymes, hydrogen bond breaking agents, such as swollenin, and mixtures thereof.

A. Bleaching System—The cleaning compositions of the present invention preferably comprise a bleaching system. Bleaching systems typically comprise a “bleaching agent” (source of hydrogen peroxide) and an “initiator” or “catalyst”. When present, bleaching agents will typically be at levels of from about 1%, preferably from about 5% to about 30%, preferably to about 20% by weight of the composition. If present, the amount of bleach activator will typically be from about 0.1%, preferably from about 0.5% to about 60%, preferably to about 40% by weight, of the bleaching composition comprising the bleaching agent-plus-bleach activator.

Bleaching Agents—Hydrogen peroxide sources are described in detail in the herein incorporated Kirk Othmer's Encyclopedia of Chemical Technology, 4th Ed (1992, John Wiley & Sons), Vol. 4, pp. 271-300 “Bleaching Agents (Survey)”, and include the various forms of sodium perborate and sodium percarbonate, including various coated and modified forms.

The preferred source of hydrogen peroxide used herein can be any convenient source, including hydrogen peroxide itself. For example, perborate, e.g., sodium perborate (any hydrate but preferably the mono- or tetra-hydrate), sodium carbonate peroxyhydrate or equivalent percarbonate salts, sodium pyrophosphate peroxyhydrate, urea peroxyhydrate, or sodium peroxide can be used herein. Also useful are sources of available oxygen such as persulfate bleach (e.g., OXONE, manufactured by DuPont). Sodium perborate monohydrate and sodium percarbonate are particularly preferred. Mixtures of any convenient hydrogen peroxide sources can also be used.

A preferred percarbonate bleach comprises dry particles having an average particle size in the range from about 500 micrometers to about 1,000 micrometers, not more than about 10% by weight of said particles being smaller than about 200 micrometers and not more than about 10% by weight of said particles being larger than about 1,250 micrometers. Optionally, the percarbonate can be coated with a silicate, borate or water-soluble surfactants. Percarbonate is available from various commercial sources such as FMC, Solvay and Tokai Denka.

Compositions of the present invention may also comprise as the bleaching agent a chlorine-type bleaching material. Such agents are well known in the art, and include for example sodium dichloroisocyanurate (“NaDCC”). However, chlorine-type bleaches are less preferred for compositions which comprise enzymes.

If peroxygen bleaching agents are used as all or part of the particulate material, they will generally comprise from about 0.1% to 30% by weight of the composition. More preferably, peroxygen bleaching agent will comprise from about 1% to 20% by weight of the composition. Most preferably, peroxygen bleaching agent will be present to the extent of from about 5% to 20% by weight of the composition.

(a) Bleach Activators—Preferably, the peroxygen bleach component in the composition is formulated with an activator (peracid precursor). The activator is present at levels of from about 0.01%, preferably from about 0.5%, more preferably from about 1%, most preferably from about 3% to about 20%, preferably to about 15%, more preferably to about 10%, most preferably to about 8%, by weight of the composition. Frequently, activators are employed such that the molar ratio of bleaching agent to activator ranges from about 1:1 to 10:1, more preferably from about 1.5:1 to 5:1. In addition, it has been found that bleach activators, when agglomerated with certain acids such as citric acid, are more chemically stable.

Preferred activators are selected from the group consisting of tetraacetyl ethylene diamine (TAED), benzoylcaprolactam (BzCL), 4-nitrobenzoylcaprolactam, 3-chlorobenzoylcaprolactam, benzoyloxybenzenesulphonate (BOBS), nonanoyloxybenzenesulphonate (NOBS), phenyl benzoate (PhBz), decanoyloxybenzenesulphonate (C₁₀-OBS), benzoylvalerolactam (BZVL), octanoyloxybenzenesulphonate (C₈-OBS), perhydrolyzable esters and mixtures thereof, most preferably benzoylcaprolactam and benzoylvalerolactam. Particularly preferred bleach activators in the pH range from about 8 to about 9.5 are those selected having an OBS or VL leaving group.

Preferred hydrophobic bleach activators include, but are not limited to, nonanoyloxybenzenesulphonate (NOBS), 4-[N-(nonaoyl) amino hexanoyloxy]-benzene sulfonate sodium salt (NACA-OBS) an example of which is described in U.S. Pat. No. 5,523,434, dodecanoyloxybenzenesulphonate (LOBS or C₁₂-OBS), 10-undecenoyloxybenzenesulfonate (UDOBS or C₁₁-OBS with unsaturation in the 10 position), and decanoyloxybenzoic acid (DOBA).

Preferred bleach activators are those described in U.S. Pat. No. 5,698,504 Christie et al., issued Dec. 16, 1997; U.S. Pat. No. 5,695,679 Christie et al. issued Dec. 9, 1997; U.S. Pat. No. 5,686,401 Willey et al., issued Nov. 11, 1997; U.S. Pat. No. 5,686,014 Hartshorn et al., issued Nov. 11, 1997; U.S. Pat. No. 5,405,412 Willey et al., issued Apr. 11, 1995; U.S. Pat. No. 5,405,413 Willey et al., issued Apr. 11, 1995; U.S. Pat. No. 5,130,045 Mitchel et al., issued Jul. 14, 1992; and U.S. Pat. No. 4,412,934 Chung et al., issued Nov. 1, 1983, and copending patent applications U.S. Ser. Nos. 08/709,072, 08/064,564, all of which are incorporated herein by reference.

The mole ratio of peroxygen bleaching compound (as AvO) to bleach activator in the present invention generally ranges from at least 1:1, preferably from about 20:1, more preferably from about 10:1 to about 1:1, preferably to about 3:1.

Quaternary substituted bleach activators may also be included. The present cleaning compositions preferably comprise a quaternary substituted bleach activator (QSBA) or a quaternary substituted peracid (QSP); more preferably, the former. Preferred QSBA structures are further described in U.S. Pat. No. 5,686,015 Willey et al., issued Nov. 11, 1997; U.S. Pat. No. 5,654,421 Taylor et al., issued Aug. 5, 1997; U.S. Pat. No. 5,460,747 Gosselink et al., issued Oct. 24, 1995; U.S. Pat. No. 5,584,888 Miracle et al., issued Dec. 17, 1996; and U.S. Pat. No. 5,578,136 Taylor et al., issued Nov. 26, 1996; all of which are incorporated herein by reference.

Highly preferred bleach activators useful herein are amide-substituted as described in U.S. Pat. Nos. 5,698,504, 5,695,679, and 5,686,014 each of which are cited herein above. Preferred examples of such bleach activators include: (6-octanamidocaproyl) oxybenzenesulfonate, (6-nonanamidocaproyl)oxybenzenesulfonate, (6-decanamidocaproyl)oxybenzenesulfonate and mixtures thereof.

Other useful activators, disclosed in U.S. Pat. Nos. 5,698,504, 5,695,679, 5,686,014 each of which is cited herein above and U.S. Pat. No. 4,966,723 Hodge et al., issued Oct. 30, 1990, include benzoxazin-type activators, such as a C₆H₄ ring to which is fused in the 1,2-positions a moiety —C(O)OC(R¹)═N—.

Depending on the activator and precise application, good bleaching results can be obtained from bleaching systems having with in-use pH of from about 6 to about 13, preferably from about 9.0 to about 10.5. Typically, for example, activators with electron-withdrawing moieties are used for near-neutral or sub-neutral pH ranges. Alkalis and buffering agents can be used to secure such pH.

Acyl lactam activators, as described in U.S. Pat. Nos. 5,698,504, 5,695,679 and 5,686,014, each of which is cited herein above, are very useful herein, especially the acyl caprolactams (see for example WO 94-28102 A) and acyl valerolactams (see U.S. Pat. No. 5,503,639 Willey et al., issued Apr. 2, 1996 incorporated herein by reference).

Cyclic imido bleach activators are represented by the formula:

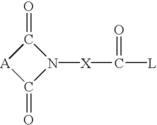

wherein X is selected from substituted or unsubstituted, branched or linear C₁-C₂₀ alkyl, substituted or unsubstituted, branched or linear C₂-C₂₀ alkylene. Preferably, X is branched or linear C₁-C₁₂ alkyl, branched or linear C₂-C₁₂ alkylene, more preferably branched or linear C₁-C₈ alkyl, branched or linear C₂-C₈ alkylene, most preferably linear C₁-C₆ alkyl. A is selected from:

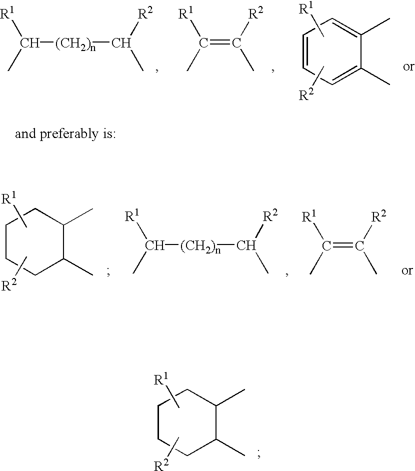

wherein n is selected from the numbers 0, 1, 2, 3 or 4. Preferably, n is 0, 1, 2 or 3 and more preferably, 0, 1, or 2. R¹ and R² are independently selected from the group consisting of hydrogen, chloride, bromide, iodide, substituted or unsubstituted branched or linear C₁-C₂₀ alkyl, substituted or unsubstituted branched or linear C₂-C₂₀ alkenyl, substituted or unsubstituted aryl, and substituted or unsubstituted alkylaryl. Preferably R¹ and R² are independently hydrogen, chloride, substituted or unsubstituted branched or linear C₁-C₁₈ alkyl, substituted or unsubstituted branched or linear C₂-C₁₈ alkenyl, substituted or unsubstituted aryl, and substituted or unsubstituted alkylaryl. More preferably, R¹ and R² are independently hydrogen, unsubstituted branched or linear C₁-C₁₆ alkyl, unsubstituted branched or linear C₂-C₁₆ alkenyl, substituted or unsubstituted phenyl, substituted or unsubstituted napthyl, substituted or unsubstituted alkylphenyl substituted or unsubstituted alkylnapthyl. It is further preferred that one of R¹ and R² is hydrogen or unsubstituted branched or linear C₁-C₆ alkyl and the other is either an unsubstituted branched or linear C₁-C₁₆ alkyl or an unsubstituted branched or linear C₂-C₁₆ alkenyl.

L is a modified or unmodified lactam leaving group. The lactams which are suitable as leaving groups in the present application have the generic structure:

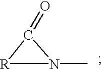

where R represents an optionally substituted alkenyl chain with at least two carbon atoms in the alkenyl chain. This alkenyl chain forms a cyclic structure with the —N— and —C(O)—. The term modified means that the alkenyl can be substituted at least once or that one or more of the alkenyl carbon atoms can be substituted by a suitable heterocycle or any combination of both. Suitable heterocyclic chain substitutes are O, N, and S, with O being preferred. Suitable substituents include, but are not limited to, C₁-C₆ alkyl, C₁-C₆ alkenyl, C₁-C₆ alkoxy, chloride, bromide, iodide. The preferred substituents are C₁-C₆ alkyl, C₁-C₆ alkoxy and chloride. The most preferred modified lactam leaving groups are: alpha-chlorocaprolactam, alpha-chloro-valerolactam, alpha,alpha-dichlorolactam, alpha,alpha-dichlorovalerolactam, alpha-methoxycaprolactam, alpha-methoxy-valerolactam,

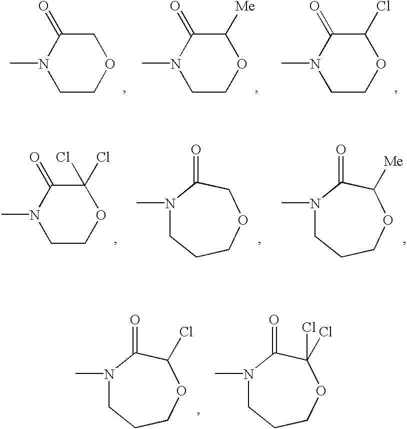

and mixtures thereof.

When the lactams are unmodified, it means that they are contain no substituents other that hydrogen and have no heterocyclic substitution of the alkenyl chain of R. R is preferably an alkenyl chain of two to seven carbon atoms. It is preferred that the lactam leaving group will be unmodified. It is more preferred that the unsubstituted lactam leaving group will be either caprolactam or valerolactam. That is:

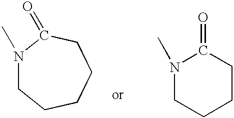

(b) Organic Peroxides, especially Diacyl Peroxides—These are extensively illustrated in Kirk Othmer, Encyclopedia of Chemical Technology, Vol. 17, John Wiley and Sons, 1982 at pages 27-90 and especially at pages 63-72, all incorporated herein by reference. If a diacyl peroxide is used, it will preferably be one which exerts minimal adverse impact on spotting/filming.

(c) Metal-containing Bleach Catalysts—The present invention compositions and methods may utilize metal-containing bleach catalysts that are effective for use in bleaching compositions. Preferred are manganese and cobalt-containing bleach catalysts.

One type of metal-containing bleach catalyst is a catalyst system comprising a transition metal cation of defined bleach catalytic activity, such as copper, iron, titanium, ruthenium tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methylenephosphonic acid) and water-soluble salts thereof. Such catalysts are disclosed in U.S. Pat. No. 4,430,243 Bragg, issued Feb. 2, 1982.

Manganese Metal Complexes—If desired, the compositions herein can be catalyzed by means of a manganese compound. Such compounds and levels of use are well known in the art and include, for example, the manganese-based catalysts disclosed in U.S. Pat. Nos. 5,576,282; 5,246,621; 5,244,594; 5,194,416; and 5,114,606; and European Pat. App. Pub. Nos. 549,271 A1, 549,272 A1, 544,440 A2, and 544,490 A1; Preferred examples of these catalysts include Mn^{IV}₂(u-O)₃(1,4,7-trimethyl-1,4,7-triazacyclononane)₂(PF₆)₂, Mn^{III}₂(u-O)₁(u-OAc)₂(1,4,7-trimethyl-1,4,7-triazacyclo-nonane)₂(ClO₄)₂, Mn^{IV}₄(u-O)₆(1,4,7-triazacyclononane)₄(ClO₄)₄, Mn^{III}Mn^{IV}₄(u-O)₁(u-OAc)₂-(1,4,7-trimethyl-1,4,7-triazacyclononane)₂(ClO₄)₃, Mn^{IV}(1,4,7-trimethyl-1,4,7-triazacyclononane)-(OCH₃)₃(PF₆), and mixtures thereof. Other metal-based bleach catalysts include those disclosed in U.S. Pat. Nos. 4,430,243 and 5,114,611. The use of manganese with various complex ligands to enhance bleaching is also reported in the following: U.S. Pat. Nos. 4,728,455; 5,284,944; 5,246,612; 5,256,779; 5,280,117; 5,274,147; 5,153,161; and 5,227,084.

Cobalt Metal Complexes—Cobalt bleach catalysts useful herein are known, and are described, for example, in U.S. Pat. Nos. 5,597,936; 5,595,967; and 5,703,030; and M. L. Tobe, “Base Hydrolysis of Transition-Metal Complexes”, Adv. Inorg. Bioinorg. Mech., (1983), 2, pages 1-94. The most preferred cobalt catalyst useful herein are cobalt pentaamine acetate salts having the formula [Co(NH₃)₅OAc] T_{y}, wherein “OAc” represents an acetate moiety and “T_{y}” is an anion, and especially cobalt pentaamine acetate chloride, [Co(NH₃)₅OAc]Cl₂; as well as [Co(NH₃)₅OAc](OAc)₂; [Co(NH₃)₅OAc](PF₆)₂; [Co(NH₃)₅OAc](SO₄); [Co(NH₃)₅OAc](BF₄)₂; and [Co(NH₃)₅OAc](NO₃)₂ (herein “PAC”).

These cobalt catalysts are readily prepared by known procedures, such as taught for example in U.S. Pat. Nos. 5,597,936; 5,595,967; and 5,703,030; in the Tobe article and the references cited therein; and in U.S. Pat. No. 4,810,410; J. Chem. Ed. (1989), 66 (12), 1043-45; The Synthesis and Characterization of Inorganic Compounds, W. L. Jolly (Prentice-Hall; 1970), pp. 461-3; Inorg. Chem., 18, 1497-1502 (1979); Inorg. Chem., 21 2881-2885 (1982); Inorg. Chem., 18, 2023-2025 (1979); Inorg. Synthesis, 173-176 (1960); and Journal of Physical Chemistry, 56, 22-25 (1952).

Transition Metal Complexes of Macropolycyclic Rigid Ligands—Compositions herein may also suitably include as bleach catalyst a transition metal complex of a macropolycyclic rigid ligand. The phrase “macropolycyclic rigid ligand” is sometimes abbreviated as “MRL” in discussion below. The amount used is a catalytically effective amount, suitably about 1 ppb or more, for example up to about 99.9%, more typically about 0.001 ppm or more, preferably from about 0.05 ppm to about 500 ppm (wherein “ppb” denotes parts per billion by weight and “ppm” denotes parts per million by weight).

Suitable transition metals e.g., Mn are illustrated hereinafter. “Macropolycyclic” means a MRL is both a macrocycle and is polycyclic. “Polycyclic” means at least bicyclic. The term “rigid” as used herein herein includes “having a superstructure” and “cross-bridged”. “Rigid” has been defined as the constrained converse of flexibility: see D. H. Busch., Chemical Reviews., (1993), 93, 847-860, incorporated by reference. More particularly, “rigid” as used herein means that the MRL must be determinably more rigid than a macrocycle (“parent macrocycle”) which is otherwise identical (having the same ring size and type and number of atoms in the main ring) but lacking a superstructure (especially linking moieties or, preferably cross-bridging moieties) found in the MRL's. In determining the comparative rigidity of macrocycles with and without superstructures, the practitioner will use the free form (not the metal-bound form) of the macrocycles. Rigidity is well-known to be useful in comparing macrocycles; suitable tools for determining, measuring or comparing rigidity include computational methods (see, for example, Zimmer, Chemical Reviews, (1995), 95(38), 2629-2648 or Hancock et al., Inorganica Chimica Acta, (1989), 164, 73-84.

Preferred MRL's herein are a special type of ultra-rigid ligand which is cross-bridged. A “cross-bridge” is nonlimitingly illustrated in 1.11 hereinbelow. In 1.11, the cross-bridge is a —CH₂CH₂-moiety. It bridges N¹ and N⁸ in the illustrative structure. By comparison, a “same-side” bridge, for example if one were to be introduced across N¹ and N¹² in 1.11, would not be sufficient to constitute a “cross-bridge” and accordingly would not be preferred.

Suitable metals in the rigid ligand complexes include Mn(II), Mn(III), Mn(IV), Mn(V), Fe(II), Fe(III), Fe(IV), Co(I), Co(II), Co(III), Ni(I), Ni(II), Ni(III), Cu(I), Cu(II), Cu(III), Cr(II), Cr(III), Cr(IV), Cr(V), Cr(VI), V(III), V(IV), V(V), Mo(IV), Mo(V), Mo(VI), W(IV), W(V), W(VI), Pd(II), Ru(II), Ru(III), and Ru(IV). Preferred transition-metals in the instant transition-metal bleach catalyst include manganese, iron and chromium.

More generally, the MRL's (and the corresponding transition-metal catalysts) herein suitably comprise:

(a) at least one macrocycle main ring comprising four or more heteroatoms; and

(b) a covalently connected non-metal superstructure capable of increasing the rigidity of the macrocycle, preferably selected from

(i) a bridging superstructure, such as a linking moiety;

(ii) a cross-bridging superstructure, such as a cross-bridging linking moiety; and

(iii) combinations thereof.

The term “superstructure” is used herein as defined in the literature by Busch et al., see, for example, articles by Busch in “Chemical Reviews”.

Preferred superstructures herein not only enhance the rigidity of the parent macrocycle, but also favor folding of the macrocycle so that it co-ordinates to a metal in a cleft. Suitable superstructures can be remarkably simple, for example a linking moiety such as any of those illustrated in FIG. 1 and FIG. 2 below, can be used.

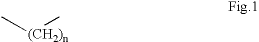

wherein n is an integer, for example from 2 to 8, preferably less than 6, typically 2 to 4, or

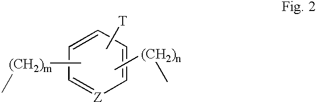

wherein m and n are integers from about 1 to 8, more preferably from 1 to 3; Z is N or CH; and T is a compatible substituent, for example H, alkyl, trialkylammonium, halogen, nitro, sulfonate, or the like. The aromatic ring in 1.10 can be replaced by a saturated ring, in which the atom in Z connecting into the ring can contain N, O, S or C.

Suitable MRL's are further nonlimitingly illustrated by the following compound:

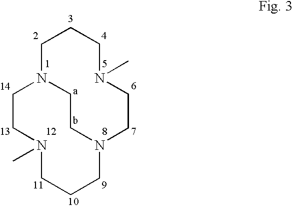

This is a MRL in accordance with the invention which is a highly preferred, cross-bridged, methyl-substituted (all nitrogen atoms tertiary) derivative of cyclam. Formally, this ligand is named 5,12-dimethyl-1,5,8,12-tetraazabicyclo[6.6.2]hexadecane using the extended von Baeyer system. See “A Guide to IUPAC Nomenclature of Organic Compounds: Recommendations 1993”, R. Panico, W. H. Powell and J-C Richer (Eds.), Blackwell Scientific Publications, Boston, 1993; see especially section R-2.4.2.1.

Transition-metal bleach catalysts of Macrocyclic Rigid Ligands which are suitable for use in the invention compositions can in general include known compounds where they conform with the definition herein, as well as, more preferably, any of a large number of novel compounds expressly designed for the present laundry or cleaning uses, and non-limitingly illustrated by any of the following:

Dichloro-5,12-dimethyl-1,5,8,12-tetraazabicyclo[6.6.2]hexadecane Manganese(II)

Diaquo-5,12-dimethyl-1,5,8,12-tetraazabicyclo[6.6.2]hexadecane Manganese(II) Hexafluorophosphate

Aquo-hydroxy-5,12-dimethyl-1,5,8,12-tetraazabicyclo[6.6.2]hexadecane Manganese(III) Hexafluorophosphate

Diaquo-5,12-dimethyl-1,5,8,12-tetraazabicyclo[6.6.2]hexadecane Manganese(II) Tetrafluoroborate

Dichloro-5,12-dimethyl-1,5,8,12-tetraazabicyclo[6.6.2]hexadecane Manganese(III) Hexafluorophosphate

Dichloro-5,12-di-n-butyl-1,5,8,12-tetraaza bicyclo[6.6.2]hexadecane Manganese(II)

Dichloro-5,12-dibenzyl-1,5,8,12-tetraazabicyclo[6.6.2]hexadecane Manganese(II)

Dichloro-5-n-butyl-12-methyl-1,5,8,12-tetraaza-bicyclo[6.6.2]hexadecane Manganese(II)

Dichloro-5-n-octyl-12-methyl-1,5,8,12-tetraaza-bicyclo [6.6.2]hexadecane Manganese(II)

Dichloro-5-n-butyl-12-methyl-1,5,8,12-tetraaza-bicyclo[6.6.2]hexadecane Manganese(II).

As a practical matter, and not by way of limitation, the compositions and cleaning processes herein can be adjusted to provide on the order of at least one part per hundred million of the active bleach catalyst species in the aqueous washing medium, and will preferably provide from about 0.01 ppm to about 25 ppm, more preferably from about 0.05 ppm to about 10 ppm, and most preferably from about 0.1 ppm to about 5 ppm, of the bleach catalyst species in the wash liquor. In order to obtain such levels in the wash liquor of an automatic washing process, typical compositions herein will comprise from about 0.0005% to about 0.2%, more preferably from about 0.004% to about 0.08%, of bleach catalyst, especially manganese or cobalt catalysts, by weight of the bleaching compositions.

(d) Other Bleach Catalysts—The compositions herein may comprise one or more other bleach catalysts. Preferred bleach catalysts are zwitterionic bleach catalysts, which are described in U.S. Pat. No. 5,576,282 (especially 3-(3,4-dihydroisoquinolinium) propane sulfonate. Other bleach catalysts include cationic bleach catalysts are described in U.S. Pat. Nos. 5,360,569, 5,442,066, 5,478,357, 5,370,826, 5,482,515, 5,550,256, and WO 95/13351, WO 95/13352, and WO 95/13353.

As a practical matter, and not by way of limitation, the compositions and cleaning processes herein can be adjusted to provide on the order of at least one part per hundred million of the active bleach catalyst species in the aqueous washing medium, and will preferably provide from about 0.01 ppm to about 25 ppm, more preferably from about 0.05 ppm to about 10 ppm, and most preferably from about 0.1 ppm to about 5 ppm, of the bleach catalyst species in the wash liquor. In order to obtain such levels in the wash liquor of an automatic washing process, typical compositions herein will comprise from about 0.0005% to about 0.2%, more preferably from about 0.004% to about 0.08%, of bleach catalyst, especially manganese or cobalt catalysts, by weight of the cleaning compositions.

(e) Preformed peracids—Also suitable as bleaching agents are preformed peracids, such as phthalimido-peroxy-caproic acid (“PAP”). See for example U.S. Pat. Nos. 5,487,818, 5,310,934, 5,246,620, 5,279,757 and 5,132,431.

Bleach containing detergent compositions are known to impact on the dyes of colored garments, but bleaches provide effective cleaning. It has now surprisingly been found that a detergent composition containing both bleach and the XET/xyloglucan system exhibits improved cleaning performance by bleaching with minimal impact on color integrity of the fabrics by the bleach. Not to be bound by theory, it is anticipated that the XET/xyloglucan combination provides a protective layer of xyloglucan on the fabric surface and as such prevents the bleach action on the dyes of colored garments. A preferred combination is the XET/xyloglucan system with NOBS and/or hexanoic acid, 6-[(1-oxononyl)amino]-4-sulfophenyl ester, monosodium salt.

B. Cellulase Enzymes—Suitable cellulases for use in the laundry and/or fabric care compositions of the present invention include, but are not limited to, both bacterial and fungal cellulases. Preferably, they will have a pH optimum of between 5 and 12 and a specific activity above 50 CEVU/mg (Cellulose Viscosity Unit). Suitable cellulases are disclosed in U.S. Pat. No. 4,435,307, J61078384 and WO96/02653 which discloses fungal cellulase produced respectively from Humicola insolens, Trichoderma, Thielavia and Sporotrichum. EP 739 982 describes cellulases isolated from novel Bacillus species. Suitable cellulases are also disclosed in GB-A-2.075.028; GB-A-2.095.275; DE-OS-2.247.832 and WO95/26398.

Examples of such cellulases are cellulases produced by a strain of Humicola insolens (Humicola grisea var. thermoidea), particularly the Humicola strain DSM 1800.

Other suitable cellulases are cellulases originated from Humicola insolens having a molecular weight of about 50 KDa, an isoelectric point of 5.5 and containing 415 amino acids; and a ^{˜}43kD endoglucanase derived from Humicola insolens, DSM 1800, exhibiting cellulase activity; a preferred endoglucanase component has the amino acid sequence disclosed in WO 91/17243. Also suitable cellulases are the EGIII cellulases from Trichoderma longibrachiatum described in WO94/21801 to Genencor. Especially suitable cellulases are the cellulases having color care benefits. Examples of such cellulases are cellulases described in European patent application No. 91202879.2, filed Nov. 6, 1991 (Novo). CAREZYME® and CELLUZYME® are especially useful in the compositions of the present invention and are commercially available from Novo Nordisk A/S. See also WO91/17244 and WO91/21801. Other suitable cellulases for fabric care and/or cleaning properties are described in WO96/34092, WO96/17994 and WO95/24471.

The XET/xyloglucan system provides pill prevention and cellulases are known to give pill removal. The combined action of both the XET/xyloglucan system and the cellulase give a synergistic effect on the number of pills on the fabric surface. Not to be bound to theory, it is believed that the XET/xylogucan combination glues cotton fibers together, preventing the fibers from forming pills on the fabric surface, while the cellulase removes the pills which eventually were formed or were already formed on old fabrics not treated with the XET/xyloglucan system containing detergent composition. Ideally a much lower cellulase concentration can be used to generate the same effect. A preferred combination is the XET/xyloglucan system with CAREZYME.

Cellulases, when present, are normally incorporated in the laundry and/or fabric care composition at levels from about 0.0001% to about 2%, preferably from about 0.001% to about 0.2%, more preferably from about 0.005% to about 0.1% of pure enzyme by weight of the laundry and/or fabric care composition.

C. Hydrogen Bond Breaking Agents—Suitable hydrogen bond breaking agents include, but are not limited to, swollenin, as described in PCT Publication No. WO 99/02693 to Genencor International, lithium bromide, urea and guanidine salts.

Other Cleaning Adjunct Materials

The laundry and/or fabric care compositions of the present invention comprise an effective amount of the crude cotyledon extract, and preferably one or more of the above-described preferred ingredients, and optionally one or more of the following conventional cleaning adjunct materials either to improve the performance of the crude cotyledon extract, e.g., in the areas of wrinkle control, anti-wear, soil release, tensile strength and the like, or to provide additional benefits, such as odor control, antimicrobial, and the like. The useful optional cleaning adjunct materials are those that are compatible with the crude cotyledon extract, in that they do not interfere and/or substantially or significantly diminish the benefits provided by the crude cotyledon extract. The precise nature of these optional cleaning adjunct materials, and levels of incorporation thereof will depend on the physical form of the laundry and/or fabric care compositions, and the nature of the cleaning operation for which it is to be used.

Examples of such detergent ingredients include, but are not limited to, the following.

Surfactant System—Detersive surfactants included in the fully-formulated bleaching compositions afforded by the present invention comprises at least 0.01%, preferably at least about 0.1%, more preferably at least about 0.5%, most preferably at least about 1% to about 60%, more preferably to about 35%, most preferably to about 30% by weight of bleaching composition depending upon the particular surfactants used and the desired effects.

The detersive surfactant can be nonionic, anionic, ampholytic, zwitterionic, cationic, semi-polar nonionic, and mixtures thereof, nonlimiting examples of which are disclosed in U.S. Pat. Nos. 5,707,950 and 5,576,282. Preferred laundry and/or fabric care compositions comprise anionic detersive surfactants or mixtures of anionic surfactants with other surfactants, especially nonionic surfactants.

Anionic surfactants are highly preferred for use with the organic catalyts and bleaching compositions of the present invention.

Nonlimiting examples of surfactants useful herein include the conventional C₁₁-C₁₈ alkyl benzene sulfonates and primary, secondary and random alkyl sulfates, the C₁₀-C₁₈ alkyl alkoxy sulfates, the C₁₀-C₁₈ alkyl polyglycosides and their corresponding sulfated polyglycosides, C₁₂-C₁₈ alpha-sulfonated fatty acid esters, C₁₂-C₁₈ alkyl and alkyl phenol alkoxylates (especially ethoxylates and mixed ethoxy/propoxy), C₁₂-C₁₈ betaines and sulfobetaines (“sultaines”), C₁₀-C₁₈ amine oxides, and the like. Other conventional useful surfactants are listed in standard texts.

The surfactant is preferably formulated to be compatible with enzyme components present in the composition. In liquid or gel compositions the surfactant is most preferably formulated such that it promotes, or at least does not degrade, the stability of any enzyme in these compositions.

Nonionic Surfactants—Polyethylene, polypropylene, and polybutylene oxide condensates of alkyl phenols are suitable for use as the nonionic surfactant of the surfactant systems of the present invention, with the polyethylene oxide condensates being preferred. Commercially available nonionic surfactants of this type include Igepal™ CO-630, marketed by the GAF Corporation; and Triton™ X-45, X-114, X-100 and X-102, all marketed by the Rohm & Haas Company. These surfactants are commonly referred to as alkylphenol alkoxylates (e.g., alkyl phenol ethoxylates).

The condensation products of primary and secondary aliphatic alcohols with from about 1 to about 25 moles of ethylene oxide are suitable for use as the nonionic surfactant of the nonionic surfactant systems of the present invention. Examples of commercially available nonionic surfactants of this type include Tergitol™ 15-S-9 (the condensation product of C₁₁-C₁₅ linear alcohol with 9 moles ethylene oxide), Tergitol™ 24-L-6 NMW (the condensation product of C₁₂-C₁₄ primary alcohol with 6 moles ethylene oxide with a narrow molecular weight distribution), both marketed by Union Carbide Corporation; Neodol™ 45-9 (the condensation product of C₁₄-C₁₅ linear alcohol with 9 moles of ethylene oxide), Neodol™ 23-3 (the condensation product of C₁₂-C₁₃ linear alcohol with 3.0 moles of ethylene oxide), Neodol™ 45-7 (the condensation product of C₁₄-C₁₅ linear alcohol with 7 moles of ethylene oxide), Neodol™ 45-5 (the condensation product of C₁₄-C₁₅ linear alcohol with 5 moles of ethylene oxide) marketed by Shell Chemical Company, Kyro™ EOB (the condensation product of C₁₃-C₁₅ alcohol with 9 moles ethylene oxide), marketed by The Procter & Gamble Company, and Genapol LA O3O or O5O (the condensation product of C₁₂-C₁₄ alcohol with 3 or 5 moles of ethylene oxide) marketed by Hoechst. Preferred range of HLB in these products is from 8-11 and most preferred from 8-10.

Also useful as the nonionic surfactant of the surfactant systems of the present invention are the alkylpolysaccharides disclosed in U.S. Pat. No. 4,565,647.

Preferred alkylpolyglycosides have the formula: R²O(CₙH₂ₙO)ₜ(glycosyl)ₓ wherein R² is selected from the group consisting of alkyl, alkylphenyl, hydroxyalkyl, hydroxyalkylphenyl, and mixtures thereof in which the alkyl groups contain from about 10 to about 18, preferably from about 12 to about 14, carbon atoms; n is 2 or 3, preferably 2; t is from 0 to about 10, preferably 0; and x is from about 1.3 to about 10, preferably from about 1.3 to about 3, most preferably from about 1.3 to about 2.7.

The condensation products of ethylene oxide with a hydrophobic base formed by the condensation of propylene oxide with propylene glycol are also suitable for use as the additional nonionic surfactant systems of the present invention. Examples of compounds of this type include certain of the commercially-available Plurafac™ LF404 and Pluronic™ surfactants, marketed by BASF.

Also suitable for use as the nonionic surfactant of the nonionic surfactant system of the present invention, are the condensation products of ethylene oxide with the product resulting from the reaction of propylene oxide and ethylenediamine. Examples of this type of nonionic surfactant include certain of the commercially available Tetronic™ compounds, marketed by BASF.

Preferred for use as the nonionic surfactant of the surfactant systems of the present invention are polyethylene oxide condensates of alkyl phenols, condensation products of primary and secondary aliphatic alcohols with from about 1 to about 25 moles of ethylene oxide, alkylpolysaccharides, and mixtures thereof. Most preferred are C₈-C₁₄ alkyl phenol ethoxylates having from 3 to 15 ethoxy groups and C₈-C₁₈ alcohol ethoxylates (preferably C₁₀ avg.) having from 2 to 10 ethoxy groups, and mixtures thereof.

Highly preferred nonionic surfactants are polyhydroxy fatty acid amide surfactants of the formula: R²—C(O)—N(R¹)—Z wherein R¹ is H, or R¹ is C₁₋₄ hydrocarbyl, 2-hydroxy ethyl, 2-hydroxy propyl or a mixture thereof, R² is C₅₋₃₁ hydrocarbyl, and Z is a polyhydroxyhydrocarbyl having a linear hydrocarbyl chain with at least 3 hydroxyls directly connected to the chain, or an alkoxylated derivative thereof. Preferably, R¹ is methyl, R² is a straight C₁₁₋₁₅ alkyl or C₁₆₋₁₈ alkyl or alkenyl chain such as coconut alkyl or mixtures thereof, and Z is derived from a reducing sugar such as glucose, fructose, maltose, lactose, in a reductive amination reaction.

Anionic Surfactants—Suitable anionic surfactants to be used are linear alkyl benzene sulfonate, alkyl ester sulfonate surfactants including linear esters of C₈-C₂₀ carboxylic acids (i.e., fatty acids) which are sulfonated with gaseous SO₃ according to “The Journal of the American Oil Chemists Society”, 52 (1975), pp. 323-329. Suitable starting materials would include natural fatty substances as derived from tallow, palm oil, etc.

The preferred alkyl ester sulfonate surfactant, especially for laundry applications, comprise alkyl ester sulfonate surfactants of the structural formula:

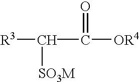

wherein R³ is a C₈-C₂₀ hydrocarbyl, preferably an alkyl, or combination thereof, R⁴ is a C₁-C₆ hydrocarbyl, preferably an alkyl, or combination thereof, and M is a cation which forms a water soluble salt with the alkyl ester sulfonate. Suitable salt-forming cations include metals such as sodium, potassium, and lithium, and substituted or unsubstituted ammonium cations, such as monoethanolamine, diethanolamine, and triethanolamine. Preferably, R³ is C₁₀-C₁₆ alkyl, and R⁴ is methyl, ethyl or isopropyl. Especially preferred are the methyl ester sulfonates wherein R³ is C₁₀-C₁₆ alkyl.

Other suitable anionic surfactants include the alkyl sulfate surfactants which are water soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation. Typically, alkyl chains of C₁₂-C₁₆ are preferred for lower wash temperatures (e.g. below about 50° C.) and C₁₆-₁₈ alkyl chains are preferred for higher wash temperatures (e.g. above about 50° C.).

Other anionic surfactants useful for detersive purposes include salts of soap, C₈-C₂₂ primary of secondary alkanesulfonates, C₈-C₂₄ olefinsulfonates, sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl glycerol sulfonates, fatty acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinates (especially saturated and unsaturated C₁₂-C₁₈ monoesters) and diesters of sulfosuccinates (especially saturated and unsaturated C₆-C₁₂ diesters), acyl sarcosinates, sulfates of alkylpolysaccharides such as the sulfates of alkylpolyglucoside (the nonionic nonsulfated compounds being described below), branched primary alkyl sulfates, and alkyl polyethoxy carboxylates such as those of the formula RO(CH₂CH₂O)ₖ—CH₂COO—M+ wherein R is a C₈-C₂₂ alkyl, k is an integer from 1 to 10, and M is a soluble salt-forming cation. Resin acids and hydrogenated resin acids are also suitable, such as rosin, hydrogenated rosin, and resin acids and hydrogenated resin acids present in or derived from tall oil.

Further examples are described in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23 (herein incorporated by reference).

Highly preferred anionic surfactants include alkyl alkoxylated sulfate surfactants hereof are water soluble salts or acids of the formula RO(A)ₘSO3M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl, trimethyl-ammonium cations and quaternary ammonium cations such as tetramethyl-ammonium and dimethyl piperdinium cations and those derived from alkylamines such as ethylamine, diethylamine, triethylamine, mixtures thereof, and the like. Exemplary surfactants are C₁₂-C₁₈ alkyl polyethoxylate (1.0) sulfate (C₁₂-C₁₈E(1.0)M), C₁₂-C₁₈ alkyl polyethoxylate (2.25) sulfate (C₁₂-C₁₈E(2.25)M), C₁₂-C₁₈ alkyl polyethoxylate (3.0) sulfate (C₁₂-C₁₈E(3.0)M), and C₁₂-C₁₈ alkyl polyethoxylate (4.0) sulfate (C₁₂-C₁₈E(4.0)M), wherein M is conveniently selected from sodium and potassium.

When included therein, the bleaching compositions of the present invention typically comprise from about 1%, preferably from about 3% to about 40%, preferably about 20% by weight of such anionic surfactants.

Cationic Surfactants—Cationic detersive surfactants suitable for use in the bleaching compositions of the present invention are those having one long-chain hydrocarbyl group. Examples of such cationic surfactants include the ammonium surfactants such as alkyltrimethylammonium halogenides, and those surfactants having the formula: [R²(OR³)_{y}][R⁴(OR³)_{y}]₂R⁵N+X− wherein R² is an alkyl or alkyl benzyl group having from about 8 to about 18 carbon atoms in the alkyl chain, each R³ is selected from the group consisting of —CH₂CH₂—, —CH₂CH(CH₃)—, —CH₂CH(CH₂OH)—, —CH₂CH₂CH₂—, and mixtures thereof; each R⁴ is selected from the group consisting of C₁-C₄ alkyl, C₁-C₄ hydroxyalkyl, benzyl ring structures formed by joining the two R⁴ groups, —CH₂CHOH—CHOHCOR⁶CHOHCH₂OH wherein R⁶ is any hexose or hexose polymer having a molecular weight less than about 1000, and hydrogen when y is not 0; R⁵ is the same as R⁴ or is an alkyl chain wherein the total number of carbon atoms of R² plus R⁵ is not more than about 18; each y is from 0 to about 10 and the sum of the y values is from 0 to about 15; and X is any compatible anion.

Highly preferred cationic surfactants are the water-soluble quaternary ammonium compounds useful in the present composition having the formula (i): R₁R₂R₃R₄N⁺X⁻ wherein R₁ is C₈-C₁₆ alkyl, each of R₂, R₃ and R₄ is independently C₁-C₄ alkyl, C₁-C₄ hydroxy alkyl, benzyl, and —(C₂H₄O)ₓH where X has a value from 2 to 5, and X is an anion. Not more than one of R₂, R₃ or R₄ should be benzyl. The preferred alkyl chain length for R₁ is C₁₂-C₁₅ particularly where the alkyl group is a mixture of chain lengths derived from coconut or palm kernel fat or is derived synthetically by olefin build up or OXO alcohols synthesis. Preferred groups for R₂R₃ and R₄ are methyl and hydroxyethyl groups and the anion X may be selected from halide, methosulfate, acetate and phosphate ions.

Examples of suitable quaternary ammonium compounds of formulae (i) for use herein are include, but are not limited to: coconut trimethyl ammonium chloride or bromide; coconut methyl dihydroxyethyl ammonium chloride or bromide; decyl triethyl ammonium chloride; decyl dimethyl hydroxyethyl ammonium chloride or bromide; C₁₂₋₁₅ dimethyl hydroxyethyl ammonium chloride or bromide; coconut dimethyl hydroxyethyl ammonium chloride or bromide; myristyl trimethyl ammonium methyl sulphate; lauryl dimethyl benzyl ammonium chloride or bromide; lauryl dimethyl (ethenoxy)₄ ammonium chloride or bromide; choline esters (compounds of formula (i)

wherein R₁ is

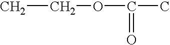

alkyl and R₂R₃R₄ are methyl);

and di-alkyl imidazolines [(i)].

Other cationic surfactants useful herein are also described in U.S. Pat. No. 4,228,044, Cambre, issued Oct. 14, 1980 and in European Patent Application EP 000,224.

When included therein, the bleaching compositions of the present invention typically comprise from about 0.2%, preferably from about 1% to about 25%, preferably to about 8% by weight of such cationic surfactants.

Ampholytic Surfactants—Ampholytic surfactants, examples of which are described in U.S. Pat. No. 3,929,678, are also suitable for use in the bleaching compositions of the present invention.

When included therein, the bleaching compositions of the present invention typically comprise from about 0.2%, preferably from about 1% to about 15%, preferably to about 10% by weight of such ampholytic surfactants.

Zwitterionic Surfactants—Zwitterionic surfactants, examples of which are described in U.S. Pat. No. 3,929,678, are also suitable for use in bleaching compositions.

When included therein, the bleaching compositions of the present invention typically comprise from about 0.2%, preferably from about 1% to about 15%, preferably to about 10% by weight of such zwitterionic surfactants.

Semi-polar Nonionic Surfactants—Semi-polar nonionic surfactants are a special category of nonionic surfactants which include water-soluble amine oxides having the formula:

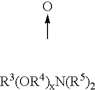

wherein R³ is an alkyl, hydroxyalkyl, or alkyl phenyl group or mixtures thereof containing from about 8 to about 22 carbon atoms; R⁴ is an alkylene or hydroxyalkylene group containing from about 2 to about 3 carbon atoms or mixtures thereof; x is from 0 to about 3; and each R⁵ is an alkyl or hydroxyalkyl group containing from about 1 to about 3 carbon atoms or a polyethylene oxide group containing from about 1 to about 3 ethylene oxide groups (the R⁵ groups can be attached to each other, e.g., through an oxygen or nitrogen atom, to form a ring structure); water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

The amine oxide surfactants in particular include C₁₀-C₁₈ alkyl dimethyl amine oxides and C₈-C₁₂ alkoxy ethyl dihydroxy ethyl amine oxides.

When included therein, the cleaning compositions of the present invention typically comprise from about 0.2%, preferably from about 1% to about 15%, preferably to about 10% by weight of such semi-polar nonionic surfactants.

Cosurfactants—The bleaching compositions of the present invention may further comprise a cosurfactant selected from the group of primary or tertiary amines. Suitable primary amines for use herein include amines according to the formula R₁NH₂ wherein R₁ is a C₆-C₁₂, preferably C₆-C₁₀ alkyl chain or R₄X(CH₂)ₙ, X is —O—, —C(O)NH— or —NH—, R₄ is a C₆-C₁₂ alkyl chain n is between 1 to 5, preferably 3. R₁ alkyl chains may be straight or branched and may be interrupted with up to 12, preferably less than 5 ethylene oxide moieties.

Preferred amines according to the formula herein above are n-alkyl amines. Suitable amines for use herein may be selected from 1-hexylamine, 1-octylamine, 1-decylamine and laurylamine. Other preferred primary amines include C₈-C₁₀ oxypropylamine, octyloxypropylamine, 2-ethylhexyl-oxypropylamine, lauryl amido propylamine and amido propylamine. The most preferred amines for use in the compositions herein are 1-hexylamine, 1-octylamine, 1-decylamine, 1-dodecylamine. Especially desirable are n-dodecyldimethylamine and bishydroxyethylcoconutalkylamine and oleylamine 7 times ethoxylated, lauryl amido propylamine and cocoamido propylamine.

LFNIs—Particularly preferred surfactants in the automatic dishwashing compositions (ADD) of the present invention are low foaming nonionic surfactants (LFNI) which are described in U.S. Pat. Nos. 5,705,464 and 5,710,115. LFNI may be present in amounts from 0.01% to about 10% by weight, preferably from about 0.1% to about 10%, and most preferably from about 0.25% to about 4%. LFNIs are most typically used in ADDs on account of the improved water-sheeting action (especially from glass) which they confer to the ADD product. They also encompass non-silicone, nonphosphate polymeric materials further illustrated hereinafter which are known to defoam food soils encountered in automatic dishwashing.

Preferred LFNIs include nonionic alkoxylated surfactants, especially ethoxylates derived from primary alcohols, and blends thereof with more sophisticated surfactants, such as the polyoxypropylene/polyoxyethylene/polyoxypropylene (PO/EO/PO) reverse block polymers as described in U.S. Pat. Nos. 5,705,464 and 5,710,115.

LFNIs which may also be used include those POLY-TERGENT® SLF-18 nonionic surfactants from Olin Corp., and any biodegradable LFNI having the melting point properties discussed hereinabove.

These and other nonionic surfactants are well known in the art, being described in more detail in Kirk Othmer's Encyclopedia of Chemical Technology, 3rd Ed., Vol. 22, pp. 360-379, “Surfactants and Detersive Systems”, incorporated by reference herein.

Optional Detersive Enzymes—The laundry and/or fabric care compositions herein may also optionally contain one or more types of detergent enzymes. Such enzymes can include other proteases, amylases and lipases. They may be incorporated into the non-aqueous liquid detergent compositions herein in the form of suspensions, “marumes” or “prills”. Another suitable type of enzyme comprises those in the form of slurries of enzymes in nonionic surfactants, e.g., the enzymes marketed by Novo Nordisk under the tradename “SL” or the microencapsulated enzymes marketed by Novo Nordisk under the tradename “LDP.” Suitable enzymes and levels of use are described in U.S. Pat. Nos. 5,576,282, 5,705,464 and 5,710,115.

Enzymes added to the compositions herein in the form of conventional enzyme prills are especially preferred for use herein. Such prills will generally range in size from about 100 to 1,000 microns, more preferably from about 200 to 800 microns and will be suspended throughout the non-aqueous liquid phase of the composition. Prills in the compositions of the present invention have been found, in comparison with other enzyme forms, to exhibit especially desirable enzyme stability in terms of retention of enzymatic activity over time. Thus, compositions which utilize enzyme prills need not contain conventional enzyme stabilizing such as must frequently be used when enzymes are incorporated into aqueous liquid detergents.

However, enzymes added to the compositions herein may be in the form of granulates, preferably T-granulates.

“Detersive enzyme”, as used herein, means any enzyme having a cleaning, stain removing or otherwise beneficial effect in a laundry, hard surface cleaning or personal care detergent composition. Preferred detersive enzymes are hydrolases such as proteases, amylases and lipases. Preferred enzymes for laundry purposes include, but are not limited to, proteases, cellulases, lipases and peroxidases. Highly preferred for automatic dishwashing are amylases and/or proteases, including both current commercially available types and improved types which, though more and more bleach compatible though successive improvements, have a remaining degree of bleach deactivation susceptibility.

Examples of suitable enzymes include, but are not limited to, hemicellulases, peroxidases, proteases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or mixtures thereof.

Examples of such suitable enzymes are disclosed in U.S. Pat. Nos. 5,705,464, 5,710,115, 5,576,282, 5,728,671 and 5,707,950

Peroxidase enzymes are used in combination with oxygen sources, e.g. percarbonate, perborate, persulfate, hydrogen peroxide, etc and with a phenolic substrate as bleach enhancing molecule. They are used for “solution bleaching”, i.e. to prevent transfer of dyes or pigments removed from substrates during wash operations to other substrates in the wash solution. Peroxidase enzymes are known in the art, and include, for example, horseradish peroxidase, ligninase and haloperoxidase such as chloro- and bromo-peroxidase. Suitable peroxidases and peroxidase-containing detergent compositions are disclosed, for example, in U.S. Pat. Nos. 5,705,464, 5,710,115, 5,576,282, 5,728,671 and 5,707,950, PCT International Application WO 89/099813, WO89/09813 and in European Patent application EP No. 91202882.6, filed on Nov. 6, 1991 and EP No. 96870013.8, filed Feb. 20, 1996. Also suitable is the laccase enzyme.

Enhancers are generally comprised at a level of from 0.1% to 5% by weight of total composition. Preferred enhancers are substitued phenthiazine and phenoxasine 10-Phenothiazinepropionicacid (PPT), 10-ethylphenothiazine-4-carboxylic acid (EPC), 10-phenoxazinepropionic acid (POP) and 10-methylphenoxazine (described in WO 94/12621) and substitued syringates (C3-C5 substitued alkyl syringates) and phenols. Sodium percarbonate or perborate are preferred sources of hydrogen peroxide. Said peroxidases are normally incorporated in the cleaning composition at levels from 0.0001% to 2% of pure enzyme by weight of the cleaning composition.

Enzymatic systems may be used as bleaching agents. The hydrogen peroxide may also be present by adding an enzymatic system (i.e. an enzyme and a substrate therefore) which is capable of generating hydrogen peroxide at the beginning or during the washing and/or rinsing process. Such enzymatic systems are disclosed in EP Patent Application 91202655.6 filed Oct. 9, 1991.

Other preferred enzymes that can be included in the cleaning compositions of the present invention include lipases. Suitable lipase enzymes for detergent usage include those produced by microorganisms of the Pseudomonas group, such as Pseudomonas stutzeri ATCC 19.154, as disclosed in British Patent 1,372,034. Suitable lipases include those which show a positive immunological cross-reaction with the antibody of the lipase, produced by the microorganism Pseudomonas fluorescent IAM 1057. This lipase is available from Amano Pharmaceutical Co. Ltd., Nagoya, Japan, under the trade name Lipase P “Amano,” hereinafter referred to as “Amano-P”. Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands, and lipases ex Pseudomonas gladioli. Especially suitable lipases are lipases such a M1 Lipase^{R} and Lipomax^{R} (Gist-Brocades) and Lipolase^{R} Lipolase Ultra^{R}(Novo) which have found to be very effective when used in combination with the compositions of the present invention. Also suitable are the lipolytic enzymes described in EP 258 068, WO 92/05249 and WO 95/22615 by Novo Nordisk and in WO 94/03578, WO 95/35381 and WO 96/00292 by Unilever.

Also suitable are cutinases [EC 3.1.1.50] which can be considered as a special kind of lipase, namely lipases which do not require interfacial activation. Addition of cutinases to cleaning compositions have been described in e.g. WO-A-88/09367 (Genencor); WO 90/09446 (Plant Genetic System) and WO 94/14963 and WO 94/14964 (Unilever).

Lipases and/or cutinases, when present, are normally incorporated in the cleaning composition at levels from 0.0001% to 2% of pure enzyme by weight of the cleaning composition.

In addition to the above referenced lipases, phospholipases may be incorporated into the cleaning compositions of the present invention. Nonlimiting examples of suitable phospholipases included: EC 3.1.1.32 Phospholipase A1; EC 3.1.1.4 Phospholipase A2; EC 3.1.1.5 Lysopholipase; EC 3.1.4.3 Phospholipase C; EC 3.1.4.4. Phospolipase D. Commercially available phospholipases include LECITASE® from Novo Nordisk A/S of Denmark and Phospholipase A2 from Sigma. When phospolipases are included in the compositions of the present invention, it is preferred that amylases are also included. Without desiring to be bound by theory, it is believed that the combined action of the phospholipase and amylase provide substantive stain removal, especially on greasy/oily, starchy and highly colored stains and soils. Preferably, the phospholipase and amylase, when present, are incorporated into the compositions of the present invention at a pure enzyme weight ratio between 4500:1 and 1:5, more preferably between 50:1 and 1:1.

Suitable proteases are the subtilisins which are obtained from particular strains of B. subtilis and B. licheniformis (subtilisin BPN and BPN′). One suitable protease is obtained from a strain of Bacillus, having maximum activity throughout the pH range of 8-12, developed and sold as ESPERASE® by Novo Industries A/S of Denmark, hereinafter “Novo”. The preparation of this enzyme and analogous enzymes is described in GB 1,243,784 to Novo. Proteolytic enzymes also encompass modified bacterial serine proteases, such as those described in European Patent Application Serial Number 87 303761.8, filed Apr. 28, 1987 (particularly pages 17, 24 and 98), and which is called herein “Protease B”, and in European Patent Application 199,404, Venegas, published Oct. 29, 1986, which refers to a modified bacterial serine protealytic enzyme which is called “Protease A” herein. Suitable is the protease called herein “Protease C”, which is a variant of an alkaline serine protease from Bacillus in which Lysine replaced arginine at position 27, tyrosine replaced valine at position 104, serine replaced asparagine at position 123, and alanine replaced threonine at position 274. Protease C is described in EP 90915958:4, corresponding to WO 91/06637, Published May 16, 1991. Genetically modified variants, particularly of Protease C, are also included herein.

A preferred protease referred to as “Protease D” is a carbonyl hydrolase as described in U.S. Pat. No. 5,677,272, and WO95/10591. Also suitable is a carbonyl hydrolase variant of the protease described in WO95/10591, having an amino acid sequence derived by replacement of a plurality of amino acid residues replaced in the precursor enzyme corresponding to position +210 in combination with one or more of the following residues: +33, +62, +67, +76, +100, +101, +103, +104, +107, +128, +129, +130, +132, +135, +156, +158, +164, +166, +167, +170, +209, +215, +218, and +222, where the numbered position corresponds to naturally-occurring subtilisin from Bacillus amyloliquefaciens or to equivalent amino acid residues in other carbonyl hydrolases or subtilisins, such as Bacillus lentus subtilisin (co-pending patent application U.S. Ser. No. 60/048,550, filed Jun. 04, 1997 and PCT International Application Serial No. PCT/IB98/00853).

Also suitable for the present invention are proteases described in patent applications EP 251 446 and WO 91/06637, protease BLAP® described in WO91/02792 and their variants described in WO 95/23221.

See also a high pH protease from Bacillus sp. NCIMB 40338 described in WO 93/18140 A to Novo. Enzymatic detergents comprising protease, one or more other enzymes, and a reversible protease inhibitor are described in WO 92/03529 A to Novo. When desired, a protease having decreased adsorption and increased hydrolysis is available as described in WO 95/07791 to Procter & Gamble. A recombinant trypsin-like protease for detergents suitable herein is described in WO 94/25583 to Novo. Other suitable proteases are described in EP 516 200 by Unilever.

Particularly useful proteases are described in PCT publications: WO 95/30010; WO 95/30011; and WO 95/29979. Suitable proteases are commercially available as ESPERASE®, ALCALASE®, DURAZYM®, SAVINASE®, EVERLASE® and KANNASE® all from Novo Nordisk A/S of Denmark, and as MAXATASE®, MAXACAL®, PROPERASE® and MAXAPEM® all from Genencor International (formerly Gist-Brocades of The Netherlands). Other particularly useful proteases are multiply-substituted protease variants comprising a substitution of an amino acid residue with another naturally occurring amino acid residue at an amino acid residue position corresponding to position 103 of Bacillus amyloliquefaciens subtilisin in combination with a substitution of an amino acid residue with another naturally occurring amino acid residue at one or more amino acid residue positions corresponding to positions 1, 3, 4, 8, 9, 10, 12, 13, 16, 17, 18, 19, 20, 21, 22, 24, 27, 33, 37, 38, 42, 43, 48, 55, 57, 58, 61, 62, 68, 72, 75, 76, 77, 78, 79, 86, 87, 89, 97, 98, 99, 101, 102, 104, 106, 107, 109, 111, 114, 116, 117, 119, 121, 123, 126, 128, 130, 131, 133, 134, 137, 140, 141, 142, 146, 147, 158, 159, 160, 166, 167, 170, 173, 174, 177, 181, 182, 183, 184, 185, 188, 192, 194, 198, 203, 204, 205, 206, 209, 210, 211, 212, 213, 214, 215, 216, 217, 218, 222, 224, 227, 228, 230, 232, 236, 237, 238, 240, 242, 243, 244, 245, 246, 247, 248, 249, 251, 252, 253, 254, 255, 256, 257, 258, 259, 260, 261, 262, 263, 265, 268, 269, 270, 271, 272, 274 and 275 of Bacillus amyloliquefaciens subtilisin; wherein when said protease variant includes a substitution of amino acid residues at positions corresponding to positions 103 and 76, there is also a substitution of an amino acid residue at one or more amino acid residue positions other than amino acid residue positions corresponding to positions 27, 99, 101, 104, 107, 109, 123, 128, 166, 204, 206, 210, 216, 217, 218, 222, 260, 265 or 274 of Bacillus amyloliquefaciens subtilisin and/or multiply-substituted protease variants comprising a substitution of an amino acid residue with another naturally occurring amino acid residue at one or more amino acid residue positions corresponding to positions 62, 212, 230, 232, 252 and 257 of Bacillus amyloliquefaciens subtilisin as described in PCT Publication Nos. WO 99/20727, WO 99/20726, and WO 99/20723 all owned by The Procter & Gamble Company. More preferably the protease variant includes a substitution set selected from the group consisting of:

12/76/103/104/130/222/245/261;

62/103/104/159/232/236/245/248/252;

62/103/104/159/213/232/236/245/248/252;

62/101/103/104/159/212/213/232/236/245/248/252;

68/103/104/159/232/236/245;

68/103/104/159/230/232/236/245;

68/103/104/159/209/232/236/245;

68/103/104/159/232/236/245/257;

68/76/103/104/159/213/232/236/245/260;

68A/103A/104I/159D/185D/232V/236H/245R/248D/252K;

68A/103A/104I/159D/185D/210L/232V/236H/245R/248D/252K;

68A/103A/104I/159D/210L/232V/236I/245R/248D/252K;

68A/103A/104I/159D/213G/232V/236H/245R;

98L/103A/104I/159D/232V/236H/245R/248D/252K;

98L/102A/103A/104I/159D/212G/232V/236H/245R/248D/252K;

101G/103A/104I/159D/232V/236H/245R/248D/252K;

102A/103A/104I/159D/232V/236H/245R/248D/252K;

103A/104I/159D/230V/236H/245R;

103A/104I/159D/232V/236H/245R/248D/252K;

103A/104I/159D/217E/232V/236H/245R/248D/252K;

103A/104I/130G/159D/232V/236H/245R/248D/252K;

103A/104I/131V/159D/232V/236H/245R/248D/252K;

103A/104I/159D/213R/232V/236H/245R/248D/252K; and

103A/104I/159D/232V/236H/245R.

Most preferably the protease variant includes the substitution set 101/103/104/159/232/236/245/248/252, preferably 101G/103A/104I/159D/232V/236H/245R/248D/252K.

Also suitable for the present invention are proteases described in patent applications EP 251 446 and WO 91/06637, protease BLAP® described in WO91/02792 and their variants described in WO 95/23221.

See also a high pH protease from Bacillus sp. NCIMB 40338 described in WO 93/18140 A to Novo. Enzymatic detergents comprising protease, one or more other enzymes, and a reversible protease inhibitor are described in WO 92/03529 A to Novo. When desired, a protease having decreased adsorption and increased hydrolysis is available as described in WO 95/07791 to Procter & Gamble. A recombinant trypsin-like protease for detergents suitable herein is described in WO 94/25583 to Novo. Other suitable proteases are described in EP 516 200 by Unilever.

68A/103A/104I/159D/230V/232V/236H/245R;

68A/103A/104I/159D/232V/236H/245R/257V;

68A/103A/104I/159D/213G/232V/236H/245R/248D/252K;

68A/103A/104I/159D/185D/232V/236H/245R/248D/252K;

68A/103A/104I/159D/185D/210L/232V/236H/245R/248D/252K;

68A/103A/104I/159D/210L/232V/236H/245R/248D/252K;

68A/103A/104I/159D/213G/232V/236H/245R;

98L/103A/104I/159D/232V/236H/245R/248D/252K;

98L/102A/103A/104I/159D/212G/232V/236H/245R/248D/252K;

101G/103A/104I/159D/232V/236H/245R/248D/252K;

102A/103A/104I/159D/232V/236H/245R/248D/252K;

103A/104I/159D/230V/236H/245R;

103A/104I/159D/232V/236H/245R/248D/252K;

103A/104I/159D/217B/232V/236H/245R/248D/252K;

103A/104I/130G/159D/232V/236H/245R/248D/252K;

103A/104I/131V/159D/232V/236H/245R/248D/252K;

103A/104I/159D/213R/232V/236H/245R/248D/252K; and

103A/104I/159D/232V/236H/245R.

Most preferably the protease variant includes the substitution set 101/103/104/159/232/236/245/248/252, preferably 101G/103A/104I/159D/232V/236H/245R/248D/252K.

Also suitable for the present invention are proteases described in patent applications EP 251 446 and WO 91/06637, protease BLAP® described in WO91/02792 and their variants described in WO 95/23221.

See also a high pH protease from Bacillus sp. NCIMB 40338 described in WO 93/18140 A to Novo. Enzymatic detergents comprising protease, one or more other enzymes, and a reversible protease inhibitor are described in WO 92/03529 A to Novo. When desired, a protease having decreased adsorption and increased hydrolysis is available as described in WO 95/07791 to Procter & Gamble. A recombinant trypsin-like protease for detergents suitable herein is described in WO 94/25583 to Novo. Other suitable proteases are described in EP 516 200 by Unilever.

Commercially available proteases useful in the present invention are known as ESPERASE®, ALCALASE®, DURAZYM®, SAVINASE®, EVERLASE® and KANNASE® all from Novo Nordisk A/S of Denmark, and as MAXATASE®, MAXACAL®, PROPERASE® and MAXAPEM® all from Genencor International (formerly Gist-Brocades of The Netherlands).

Such proteolytic enzymes, when present, are incorporated in the cleaning compositions of the present invention a level of from 0.0001% to 2%, preferably from 0.001% to 0.2%, more preferably from 0.005% to 0.1% pure enzyme by weight of the composition.

Amylases (α and/or β) can be included for removal of carbohydrate-based stains. WO94/02597 describes cleaning compositions which incorporate mutant amylases. See also WO95/10603. Other amylases known for use in cleaning compositions include both α- and β-amylases. α-Amylases are known in the art and include those disclosed in U.S. Pat. No. 5,003,257; EP 252,666; WO/91/00353; FR 2,676,456; EP 285,123; EP 525,610; EP 368,341; and British Patent specification no. 1,296,839 (Novo). Other suitable amylases are stability-enhanced amylases described in WO94/18314 and WO96/05295, Genencor, and amylase variants having additional modification in the immediate parent available from Novo Nordisk A/S, disclosed in WO 95/10603. Also suitable are amylases described in EP 277 216.

Examples of commercial α-amylases products are Purafect Ox Am® from Genencor and Termamyl®, Ban®, Fungamyl® Duramyl® and Natalase® all available from Novo Nordisk A/S Denmark. WO95/26397 describes other suitable amylases: α-amylases characterised by having a specific activity at least 25% higher than the specific activity of Termamyl® at a temperature range of 25° C. to 55° C. and at a pH value in the range of 8 to 10, measured by the Phadebas® α-amylase activity assay. Suitable are variants of the above enzymes, described in WO96/23873 (Novo Nordisk). Other amylolytic enzymes with improved properties with respect to the activity level and the combination of thermostability and a higher activity level are described in WO95/35382.

Such amylolytic enzymes, when present, are incorporated in the cleaning compositions of the present invention a level of from 0.0001% to 2%, preferably from 0.00018% to 0.06%, more preferably from 0.00024% to 0.048% pure enzyme by weight of the composition.

The above-mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic, halophilic, etc.). Purified or non-purified forms of these enzymes may be used. Nowadays, it is common practice to modify wild-type enzymes via protein/genetic engineering techniques in order to optimize their performance efficiency in the laundry detergent and/or fabric care compositions of the invention. For example, the variants may be designed such that the compatibility of the enzyme to commonly encountered ingredients of such compositions is increased. Alternatively, the variant may be designed such that the optimal pH, bleach or chelant stability, catalytic activity and the like, of the enzyme variant is tailored to suit the particular cleaning application.

In particular, attention should be focused on amino acids sensitive to oxidation in the case of bleach stability and on surface charges for the surfactant compatibility. The isoelectric point of such enzymes may be modified by the substitution of some charged amino acids, e.g. an increase in isoelectric point may help to improve compatibility with anionic surfactants. The stability of the enzymes may be further enhanced by the creation of e.g. additional salt bridges and enforcing calcium binding sites to increase chelant stability.

These optional detersive enzymes, when present, are normally incorporated in the cleaning composition at levels from 0.0001% to 2% of pure enzyme by weight of the cleaning composition. The enzymes can be added as separate single ingredients (prills, granulates, stabilized liquids, etc . . . containing one enzyme) or as mixtures of two or more enzymes (e.g. cogranulates).

Other suitable detergent ingredients that can be added are enzyme oxidation scavengers. Examples of such enzyme oxidation scavengers are ethoxylated tetraethylene polyamines.

A range of enzyme materials and means for their incorporation into synthetic detergent compositions is also disclosed in WO 9307263 and WO 9307260 to Genencor International, WO 8908694, and U.S. Pat. No. 3,553,139, Jan. 5, 1971 to McCarty et al. Enzymes are further disclosed in U.S. Pat. No. 4,101,457, and in U.S. Pat. No. 4,507,219. Enzyme materials useful for liquid detergent formulations, and their incorporation into such formulations, are disclosed in U.S. Pat. No. 4,261,868.

Enzyme Stabilizers—Enzymes for use in laundry and/or fabric care compositions can be stabilized by various techniques. Enzyme stabilization techniques are disclosed and exemplified in U.S. Pat. No. 3,600,319, EP 199,405 and EP 200,586. Enzyme stabilization systems are also described, for example, in U.S. Pat. No. 3,519,570. A useful Bacillus, sp. AC13 giving proteases, xylanases and cellulases, is described in WO 9401532. The enzymes employed herein can be stabilized by the presence of water-soluble sources of calcium and/or magnesium ions in the finished compositions which provide such ions to the enzymes. Suitable enzyme stabilizers and levels of use are described in U.S. Pat. Nos. 5,705,464, 5,710,115 and 5,576,282.

Builders—The laundry and/or fabric care compositions described herein preferably comprise one or more detergent builders or builder systems. When present, the compositions will typically comprise at least about 1% builder, preferably from about 5%, more preferably from about 10% to about 80%, preferably to about 50%, more preferably to about 30% by weight, of detergent builder. Lower or higher levels of builder, however, are not meant to be excluded.

Preferred builders for use in the laundry and/or fabric care compositions, particularly dishwashing compositions, described herein include, but are not limited to, water-soluble builder compounds, (for example polycarboxylates) as described in U.S. Pat. Nos. 5,695,679, 5,705,464 and 5,710,115. Other suitable polycarboxylates are disclosed in U.S. Pat. Nos. 4,144,226, 3,308,067 and 3,723,322. Preferred polycarboxylates are hydroxycarboxylates containing up to three carboxy groups per molecule, more particularly titrates.

Inorganic or P-containing detergent builders include, but are not limited to, the alkali metal, ammonium and alkanolammonium salts of polyphosphates (exemplified by the tripolyphosphates, pyrophosphates, and glassy polymeric meta-phosphates), phosphonates (see, for example, U.S. Pat. Nos. 3,159,581; 3,213,030; 3,422,021; 3,400,148 and 3,422,137), phytic acid, silicates, carbonates (including bicarbonates and sesquicarbonates), sulphates, and aluminosilicates.

However, non-phosphate builders are required in some locales. Importantly, the compositions herein function surprisingly well even in the presence of the so-called “weak” builders (as compared with phosphates) such as citrate, or in the so-called “underbuilt” situation that may occur with zeolite or layered silicate builders.

Suitable silicates include the water-soluble sodium silicates with an SiO₂:Na₂O ratio of from about 1.0 to 2.8, with ratios of from about 1.6 to 2.4 being preferred, and about 2.0 ratio being most preferred. The silicates may be in the form of either the anhydrous salt or a hydrated salt. Sodium silicate with an SiO₂:Na₂O ratio of 2.0 is the most preferred. Silicates, when present, are preferably present in the laundry and/or fabric care compositions described herein at a level of from about 5% to about 50% by weight of the composition, more preferably from about 10% to about 40% by weight.

Partially soluble or insoluble builder compounds, which are suitable for use in the laundry and/or fabric care compositions, particularly granular detergent compositions, include, but are not limited to, crystalline layered silicates, preferably crystalline layered sodium silicates (partially water-soluble) as described in U.S. Pat. No. 4,664,839, and sodium aluminosilicates (water-insoluble). When present in laundry and/or fabric care compositions, these builders are typically present at a level of from about 1% to 80% by weight, preferably from about 10% to 70% by weight, most preferably from about 20% to 60% by weight of the composition.

Crystalline layered sodium silicates having the general formula NaMSiₓO₂ₓ₊₁.yH₂O wherein M is sodium or hydrogen, x is a number from about 1.9 to about 4, preferably from about 2 to about 4, most preferably 2, and y is a number from about 0 to about 20, preferably 0 can be used in the compositions described herein. Crystalline layered sodium silicates of this type are disclosed in EP-A-0164514 and methods for their preparation are disclosed in DE-A-3417649 and DE-A-3742043. The most preferred material is delta-Na₂SiO₅, available from Hoechst AG as NaSKS-6 (commonly abbreviated herein as “SKS-6”). Unlike zeolite builders, the Na SKS-6 silicate builder does not contain aluminum. NaSKS-6 has the delta-Na₂SiO₅ morphology form of layered silicate. SKS-6 is a highly preferred layered silicate for use in the compositions described herein herein, but other such layered silicates, such as those having the general formula NaMSiₓO₂ₓ₊₁.yH₂O wherein M is sodium or hydrogen, x is a number from 1.9 to 4, preferably 2, and y is a number from 0 to 20, preferably 0 can be used in the compositions described herein. Various other layered silicates from Hoechst include NaSKS-5, NaSKS-7 and NaSKS-11, as the alpha, beta and gamma forms. As noted above, the delta-Na₂SiO₅ (NaSKS-6 form) is most preferred for use herein. Other silicates may also be useful such as for example magnesium silicate, which can serve as a crispening agent in granular formulations, as a stabilizing agent for oxygen bleaches, and as a component of suds control systems.

The crystalline layered sodium silicate material is preferably present in granular detergent compositions as a particulate in intimate admixture with a solid, water-soluble ionizable material. The solid, water-soluble ionizable material is preferably selected from organic acids, organic and inorganic acid salts and mixtures thereof.

Aluminosilicate builders are of great importance in most currently marketed heavy duty granular detergent compositions, and can also be a significant builder ingredient in liquid detergent formulations. Aluminosilicate builders have the empirical formula:

[M_{z}(AlO₂)_{y}].xH₂O

wherein z and y are integers of at least 6, the molar ratio of z to y is in the range from 1.0 to about 0.5, and x is an integer from about 15 to about 264. Preferably, the aluminosilicate builder is an aluminosilicate zeolite having the unit cell formula:

Na_{z}[(AlO₂)_{z}(SiO₂)_{y}].xH₂O

wherein z and y are at least 6; the molar ratio of z to y is from 1.0 to 0.5 and x is at least 5, preferably 7.5 to 276, more preferably from 10 to 264. The aluminosilicate builders are preferably in hydrated form and are preferably crystalline, containing from about 10% to about 28%, more preferably from about 18% to about 22% water in bound form.

These aluminosilicate ion exchange materials can be crystalline or amorphous in structure and can be naturally-occurring aluminosilicates or synthetically derived. A method for producing aluminosilicate ion exchange materials is disclosed in U.S. Pat. No. 3,985,669. Preferred synthetic crystalline aluminosilicate ion exchange materials useful herein are available under the designations Zeolite A, Zeolite B, Zeolite P, Zeolite X, Zeolite AX, Zeolite MAP and Zeolite HS and mixtures thereof. In an especially preferred embodiment, the crystalline aluminosilicate ion exchange material has the formula:

Na₁₂[(AlO₂)₁₂(SiO₂)₁₂].xH₂O

wherein x is from about 20 to about 30, especially about 27. This material is known as Zeolite A. Dehydrated zeolites (x=0−10) may also be used herein. Preferably, the aluminosilicate has a particle size of about 0.1-10 microns in diameter. Zeolite X has the formula:

Na₈₆[(AlO₂)₈₆(SiO₂)₁₀₆].276H₂O

Citrate builders, e.g., citric acid and soluble salts thereof (particularly sodium salt), are polycarboxylate builders of particular importance for heavy duty liquid detergent formulations due to their availability from renewable resources and their biodegradability. Citrates can also be used in granular compositions, especially in combination with zeolite and/or layered silicate builders. Oxydisuccinates are also especially useful in such compositions and combinations.

Also suitable in the detergent compositions described herein are the 3,3-dicarboxy-4-oxa-1,6-hexanedioates and the related compounds disclosed in U.S. Pat. No. 4,566,984. Useful succinic acid builders include the C₅-C₂₀ alkyl and alkenyl succinic acids and salts thereof. A particularly preferred compound of this type is dodecenylsuccinic acid. Specific examples of succinate builders include: laurylsuccinate, myristylsuccinate, palmitylsuccinate, 2-dodecenylsuccinate (preferred), 2-pentadecenylsuccinate, and the like. Laurylsuccinates are the preferred builders of this group, and are described in European Patent Application 86200690.5/0,200,263, published Nov. 5, 1986.

Fatty acids, e.g., C₁₂-C₁₈ monocarboxylic acids, can also be incorporated into the compositions alone, or in combination with the aforesaid builders, especially citrate and/or the succinate builders, to provide additional builder activity. Such use of fatty acids will generally result in a diminution of sudsing, which should be taken into account by the formulator.

Dispersants—One or more suitable polyalkyleneimine dispersants may be incorporated into the cleaning compositions of the present invention. Examples of such suitable dispersants can be found in European Patent Application Nos. 111,965, 111,984, and 112,592; U.S. Pat. Nos. 4,597,898, 4,548,744, and 5,565,145. However, any suitable clay/soil dispersent or anti-redepostion agent can be used in the laundry compositions of the present invention.

In addition, polymeric dispersing agents which include polymeric polycarboxylates and polyethylene glycols, are suitable for use in the present invention. Unsaturated monomeric acids that can be polymerized to form suitable polymeric polycarboxylates include acrylic acid, maleic acid (or maleic anhydride), fumaric acid, itaconic acid, aconitic acid, mesaconic acid, citraconic acid and methylenemalonic acid. Particularly suitable polymeric polycarboxylates can be derived from acrylic acid. Such acrylic acid-based polymers which are useful herein are the water-soluble salts of polymerized acrylic acid. The average molecular weight of such polymers in the acid form preferably ranges from about 2,000 to 10,000, more preferably from about 4,000 to 7,000 and most preferably from about 4,000 to 5,000. Water-soluble salts of such acrylic acid polymers can include, for example, the alkali metal, ammonium and substituted ammonium salts. Soluble polymers of this type are known materials. Use of polyacrylates of this type in detergent compositions has been disclosed, for example, in U.S. Pat. No. 3,308,067.

Acrylic/maleic-based copolymers may also be used as a preferred component of the dispersing/anti-redeposition agent. Such materials include the water-soluble salts of copolymers of acrylic acid and maleic acid. The average molecular weight of such copolymers in the acid form preferably ranges from about 2,000 to 100,000, more preferably from about 5,000 to 75,000, most preferably from about 7,000 to 65,000. The ratio of acrylate to maleate segments in such copolymers will generally range from about 30:1 to about 1:1, more preferably from about 10:1 to 2:1. Water-soluble salts of such acrylic acid/maleic acid copolymers can include, for example, the alkali metal, ammonium and substituted ammonium salts. Soluble acrylate/maleate copolymers of this type are known materials which are described in European Patent Application No. 66915, published Dec. 15, 1982, as well as in EP 193,360, published Sep. 3, 1986, which also describes such polymers comprising hydroxypropylacrylate. Still other useful dispersing agents include the maleic/acrylic/vinyl alcohol terpolymers. Such materials are also disclosed in EP 193,360, including, for example, the 45/45/10 terpolymer of acrylic/maleic/vinyl alcohol.

Another polymeric material which can be included is polyethylene glycol (PEG). PEG can exhibit dispersing agent performance as well as act as a clay soil removal-antiredeposition agent. Typical molecular weight ranges for these purposes range from about 500 to about 100,000, preferably from about 1,000 to about 50,000, more preferably from about 1,500 to about 10,000.

Polyaspartate and polyglutamate dispersing agents may also be used, especially in conjunction with zeolite builders. Dispersing agents such as polyaspartate preferably have a molecular weight (avg.) of about 10,000.

Soil Release Agents—The compositions according to the present invention may optionally comprise one or more soil release agents. If utilized, soil release agents will generally comprise from about 0.01%, preferably from about 0.1%, more preferably from about 0.2% to about 10%, preferably to about 5%, more preferably to about 3% by weight, of the composition. Nonlimiting examples of suitable soil release polymers are disclosed in: U.S. Pat. Nos. 5,728,671; 5,691,298; 5,599,782; 5,415,807; 5,182,043; 4,956,447; 4,976,879; 4,968,451; 4,925,577; 4,861,512; 4,877,896; 4,771,730; 4,711,730; 4,721,580; 4,000,093; 3,959,230; and 3,893,929; and European Patent Application 0 219 048.

Further suitable soil release agents are described in U.S. Pat. Nos. 4,201,824; 4,240,918; 4,525,524; 4,579,681; 4,220,918; and 4,787,989; EP 279,134 A; EP 457,205 A; and DE 2,335,044.

Chelating Agents—The compositions of the present invention herein may also optionally contain a chelating agent which serves to chelate metal ions and metal impurities which would otherwise tend to deactivate the bleaching agent(s). Useful chelating agents can include amino carboxylates, phosphonates, amino phosphonates, polyfunctionally-substituted aromatic chelating agents and mixtures thereof. Further examples of suitable chelating agents and levels of use are described in U.S. Pat. Nos. 5,705,464, 5,710,115, 5,728,671 and 5,576,282.

The compositions herein may also contain water-soluble methyl glycine diacetic acid (MGDA) salts (or acid form) as a chelant or co-builder useful with, for example, insoluble builders such as zeolites, layered silicates and the like.

If utilized, these chelating agents will generally comprise from about 0.1% to about 15%, more preferably from about 0.1% to about 3.0% by weight of the detergent compositions herein.

Suds suppressor—Another optional ingredient is a suds suppressor, exemplified by silicones, and silica-silicone mixtures. Examples of suitable suds suppressors are disclosed in U.S. Pat. Nos. 5,707,950 and 5,728,671. These suds suppressors are normally employed at levels of from 0.001% to 2% by weight of the composition, preferably from 0.01% to 1% by weight.

Softening agents—Fabric softening agents can also be incorporated into laundry detergent compositions in accordance with the present invention. Inorganic softening agents are exemplified by the smectite clays disclosed in GB-A-1 400 898 and in U.S. Pat. No. 5,019,292. Organic softening agents include the water insoluble tertiary amines as disclosed in GB-A-1 514 276 and EP-B-011 340 and their combination with mono C12-C14 quaternary ammonium salts are disclosed in EP-B-026 527 and EP-B-026 528 and di-long-chain amides as disclosed in EP-B-0 242 919. Other useful organic ingredients of fabric softening systems include high molecular weight polyethylene oxide materials as disclosed in EP-A-0 299 575 and 0 313 146.

Particularly suitable fabric softening agents are disclosed in U.S. Pat. Nos. 5,707,950 and 5,728,673.

Levels of smectite clay are normally in the range from 2% to 20%, more preferably from 5% to 15% by weight, with the material being added as a dry mixed component to the remainder of the formulation. Organic fabric softening agents such as the water-insoluble tertiary amines or dilong chain amide materials are incorporated at levels of from 0.5% to 5% by weight, normally from 1% to 3% by weight whilst the high molecular weight polyethylene oxide materials and the water soluble cationic materials are added at levels of from 0.1% to 2%, normally from 0.15% to 1.5% by weight. These materials are normally added to the spray dried portion of the composition, although in some instances it may be more convenient to add them as a dry mixed particulate, or spray them as molten liquid on to other solid components of the composition.

Biodegradable quaternary ammonium compounds as described in EP-A-040 562 and EP-A-239 910 have been presented as alternatives to the traditionally used di-long alkyl chain ammonium chlorides and methyl sulfates.

Non-limiting examples of softener-compatible anions for the quaternary ammonium compounds and amine precursors include chloride or methyl sulfate.

Dye transfer inhibition—The detergent compositions of the present invention can also include compounds for inhibiting dye transfer from one fabric to another of solubilized and suspended dyes encountered during fabric laundering and conditioning operations involving colored fabrics.

Polymeric Dye Transfer Inhibiting Agents

The detergent compositions according to the present invention can also comprise from 0.001% to 10%, preferably from 0.01% to 2%, more preferably from 0.05% to 1% by weight of polymeric dye transfer inhibiting agents. Said polymeric dye transfer inhibiting agents are normally incorporated into detergent compositions in order to inhibit the transfer of dyes from colored fabrics onto fabrics washed therewith. These polymers have the ability to complex or adsorb the fugitive dyes washed out of dyed fabrics before the dyes have the opportunity to become attached to other articles in the wash.

Especially suitable polymeric dye transfer inhibiting agents are polyamine N-oxide polymers, copolymers of N-vinylpyrrolidone and N-vinylimidazole, polyvinylpyrrolidone polymers, polyvinyloxazolidones and polyvinylimidazoles or mixtures thereof. Examples of such dye transfer inhibiting agents are disclosed in U.S. Pat. Nos. 5,707,950 and 5,707,951.

Additional suitable dye transfer inhibiting agents include, but are not limited to, cross-linked polymers. Cross-linked polymers are polymers whose backbone are interconnected to a certain degree; these links can be of chemical or physical nature, possibly with active groups n the backbone or on branches; cross-linked polymers have been described in the Journal of Polymer Science, volume 22, pages 1035-1039.

In one embodiment, the cross-linked polymers are made in such a way that they form a three-dimensional rigid structure, which can entrap dyes in the pores formed by the three-dimensional structure. In another embodiment, the cross-linked polymers entrap the dyes by swelling. Such cross-linked polymers are described in the co-pending European patent application 94870213.9.

Addition of such polymers also enhances the performance of the enzymes according the invention.

Odor Control Agent—The compositions for odor control are of the type disclosed in U.S. Pats. 5,534,165; 5,578,563; 5,663,134; 5,668,097; 5,670,475; and 5,714,137, Trinh et al. issued Jul. 9, 1996; Nov. 26, 1996; Sep. 2, 1997; Sep. 16, 1997; Sep. 23, 1997; and Feb. 3, 1998 respectively, all of said patents being incorporated herein by reference. Fabric care compositions of the present invention can contain several different optional odor control agents, preferably cyclodextrins, water soluble zinc salts, water soluble copper salts, and mixtures thereof.

Cyclodextrin—As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in donut-shaped rings. The specific coupling and conformation of the glucose units give the cyclodextrins a rigid, conical molecular structures with hollow interiors of specific volumes. The “lining” of each internal cavity is formed by hydrogen atoms and glycosidic bridging oxygen atoms; therefore, this surface is fairly hydrophobic. The unique shape and physical-chemical properties of the cavity enable the cyclodextrin molecules to absorb (form inclusion complexes with) organic molecules or parts of organic molecules which can fit into the cavity. Many odorous molecules can fit into the cavity including many malodorous molecules and perfume molecules. Therefore, cyclodextrins, and especially mixtures of cyclodextrins with different size cavities, can be used to control odors caused by a broad spectrum of organic odoriferous materials, which may, or may not, contain reactive functional groups. The complexation between cyclodextrin and odorous molecules occurs rapidly in the presence of water. However, the extent of the complex formation also depends on the polarity of the absorbed molecules. In an aqueous solution, strongly hydrophilic molecules (those which are highly water-soluble) are only partially absorbed, if at all. Therefore, cyclodextrin does not complex effectively with some very low molecular weight organic amines and acids when they are present at low levels on wet fabrics. As the water is being removed however, e.g., the fabric is being dried off, some low molecular weight organic amines and acids have more affinity and will complex with the cyclodextrins more readily.

The cavities within the cyclodextrin in the solution of the present invention should remain essentially unfilled (the cyclodextrin remains uncomplexed) while in solution, in order to allow the cyclodextrin to absorb various odor molecules when the solution is applied to a surface. Non-derivatised (normal) beta-cyclodextrin can be present at a level up to its solubility limit of about 1.85% (about 1.85 g in 100 grams of water) at room temperature. Beta-cyclodextrin is not preferred in compositions which call for a level of cyclodextrin higher than its water solubility limit. Non-derivatised beta-cyclodextrin is generally not preferred when the composition contains surfactant since it affects the surface activity of most of the preferred surfactants that are compatible with the derivatised cyclodextrins.

Preferably, the odor absorbing solution of the present invention is clear. The term “clear” as defined herein means transparent or translucent, preferably transparent, as in “water clear,” when observed through a layer having a thickness of less than about 10 cm.

Preferably, the cyclodextrins used in the present invention are highly water-soluble such as, alpha-cyclodextrin and/or derivatives thereof, gamma-cyclodextrin and/or derivatives thereof, derivatised beta-cyclodextrins, and/or mixtures thereof. The derivatives of cyclodextrin consist mainly of molecules wherein some of the OH groups are converted to OR groups. Cyclodextrin derivatives include, e.g., those with short chain alkyl groups such as methylated cyclodextrins, and ethylated cyclodextrins, wherein R is a methyl or an ethyl group; those with hydroxyalkyl substituted groups, such as hydroxypropyl cyclodextrins and/or hydroxyethyl cyclodextrins, wherein R is a —CH₂—CH(OH)—CH₃ or a —CH₂CH₂—OH group; branched cyclodextrins such as maltose-bonded cyclodextrins; cationic cyclodextrins such as those containing 2-hydroxy-3-(dimethylamino)propyl ether, wherein R is CH₂—CH(OH)—CH₂—N(CH₃)₂ which is cationic at low pH; quaternary ammonium, e.g., 2-hydroxy-3-(trimethylammonio)propyl ether chloride groups, wherein R is CH₂—CH(OH)—CH₂—N⁺(CH₃)₃Cl⁻; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g., the mono-3-6-anhydrocyclodextrins, as disclosed in “Optimal Performances with Minimal Chemical Modification of Cyclodextrins”, F. Diedaini-Pilard and B. Perly, The 7th International Cyclodextrin Symposium Abstracts, April 1994, p. 49, said references being incorporated herein by reference; and mixtures thereof. Other cyclodextrin derivatives are disclosed in U.S. Pat. Nos.: 3,426,011, Parmerter et al., issued Feb. 4, 1969; 3,453,257; 3,453,258; 3,453,259; and 3,453,260, all in the names of Parmerter et al., and all issued Jul. 1, 1969; 3,459,731, Gramera et al., issued Aug. 5, 1969; 3,553,191, Parmerter et al., issued Jan. 5, 1971; 3,565,887, Parmerter et al., issued Feb. 23, 1971; 4,535,152, Szejtli et al., issued Aug. 13, 1985; 4,616,008, Hirai et al., issued Oct. 7, 1986; 4,678,598, Ogino et al., issued Jul. 7, 1987; 4,638,058, Brandt et al., issued Jan. 20, 1987; and 4,746,734, Tsuchiyama et al., issued May 24, 1988; all of said patents being incorporated herein by reference.

Highly water-soluble cyclodextrins are those having water solubility of at least about 10 g in 100 ml of water at room temperature, preferably at least about 20 g in 100 ml of water, more preferably at least about 25 g in 100 ml of water at room temperature. The availability of solubilized, uncomplexed cyclodextrins is essential for effective and efficient odor control performance. Solubilized, water-soluble cyclodextrin can exhibit more efficient odor control performance than non-water-soluble cyclodextrin when deposited onto surfaces, especially fabric.

Examples of preferred water-soluble cyclodextrin derivatives suitable for use herein are hydroxypropyl alpha-cyclodextrin, methylated alpha-cyclodextrin, methylated beta-cyclodextrin, hydroxyethyl beta-cyclodextrin, and hydroxypropyl beta-cyclodextrin. Hydroxyalkyl cyclodextrin derivatives preferably have a degree of substitution of from about 1 to about 14, more preferably from about 1.5 to about 7, wherein the total number of OR groups per cyclodextrin is defined as the degree of substitution. Methylated cyclodextrin derivatives typically have a degree of substitution of from about 1 to about 18, preferably from about 3 to about 16. A known methylated beta-cyclodextrin is heptakis-2,6-di-O-methyl-β-cyclodextrin, commonly known as DIMEB, in which each glucose unit has about 2 methyl groups with a degree of substitution of about 14. A preferred, more commercially available, methylated beta-cyclodextrin is a randomly methylated beta-cyclodextrin, commonly known as RAMEB, having different degrees of substitution, normally of about 12.6. RAMEB is more preferred than DIMEB, since DIMEB affects the surface activity of the preferred surfactants more than RAMEB. The preferred cyclodextrins are available, e.g., from Cerestar USA, Inc. and Wacker Chemicals (USA), Inc.

It is also preferable to use a mixture of cyclodextrins. Such mixtures absorb odors more broadly by complexing with a wider range of odoriferous molecules having a wider range of molecular sizes. Preferably at least a portion of the cyclodextrins is alpha-cyclodextrin and its derivatives thereof, gamma-cyclodextrin and its derivatives thereof, and/or derivatised beta-cyclodextrin, more preferably a mixture of alpha-cyclodextrin, or an alpha-cyclodextrin derivative, and derivatised beta-cyclodextrin, even more preferably a mixture of derivatised alpha-cyclodextrin and derivatised beta-cyclodextrin, most preferably a mixture of hydroxypropyl alpha-cyclodextrin and hydroxypropyl beta-cyclodextrin, and/or a mixture of methylated alpha-cyclodextrin and methylated beta-cyclodextrin.

For controlling odor on fabrics, the composition is preferably used as a spray. It is preferable that the usage compositions of the present invention contain low levels of cyclodextrin so that a visible stain does not appear on the fabric at normal usage levels. Preferably, the solution used to treat the surface under usage conditions is virtually not discernible when dry. Typical levels of cyclodextrin in usage compositions for usage conditions are from about 0.01% to about 5%, preferably from about 0.1% to about 4%, more preferably from about 0.5% to about 2% by weight of the composition. Compositions with higher concentrations can leave unacceptable visible stains on fabrics as the solution evaporates off of the fabric. This is especially a problem on thin, colored, synthetic fabrics. In order to avoid or minimize the occurrence of fabric staining, it is preferable that the fabric be treated at a level of less than about 5 mg of cyclodextrin per gram of fabric, more preferably less than about 2 mg of cyclodextrin per gram of fabric. The presence of the surfactant can improve appearance by minimizing localized spotting.

Concentrated compositions can also be used in order to deliver a less expensive product. When a concentrated product is used, i.e., when the level of cyclodextrin used is from about 3% to about 20%, more preferably from about 5% to about 10%, by weight of the concentrated composition, it is preferable to dilute the concentrated composition before treating fabrics in order to avoid staining. Preferably the concentrated cyclodextrin composition is diluted with about 50% to about 6000%, more preferably with about 75% to about 2000%, most preferably with about 100% to about 1000% by weight of the concentrated composition of water. The resulting diluted compositions have usage concentrations of cyclodextrin as discussed hereinbefore, e.g., of from about 0.1% to about 5%, by weight of the diluted composition.

pH and Buffering Variation—Many of the laundry and/or fabric care compositions described herein will be buffered, i.e., they are relatively resistant to pH drop in the presence of acidic soils. However, other compositions herein may have exceptionally low buffering capacity, or may be substantially unbuffered. Techniques for controlling or varying pH at recommended usage levels more generally include the use of not only buffers, but also additional alkalis, acids, pH-jump systems, dual compartment containers, etc., and are well known to those skilled in the art.

Other Materials—Detersive ingredients or adjuncts optionally included in the instant compositions can include one or more materials for assisting or enhancing cleaning performance, treatment of the substrate to be cleaned, or designed to improve the aesthetics of the compositions. Adjuncts which can also be included in compositions of the present invention, at their conventional art-established levels for use (generally, adjunct materials comprise, in total, from about 30% to about 99.9%, preferably from about 70% to about 95%, by weight of the compositions), include other active ingredients such as clay soil removal/anti-redeposition agents, brighteners, dyes, perfumes, structure elasticizing agents, carriers, hydrotropes, processing aids, fillers, germicides, alkalinity sources, solubilizing agents and/or pigments. Suitable examples of such other detergent ingredients and levels of use are found in U.S. Pat. Nos. 5,576,282, 5,705,464, 5,710,115, 5,698,504, 5,695,679, 5,686,014 and 5,646,101.

Laundry and/or Fabric Care Compositions and Methods of Using Same

The laundry and/or fabric care compositions of the present invention comprise an effective amount of a combination of XET and a polysaccharide and/or oligosaccharide. Preferably, the laundry and/or fabric care compositions further comprise one or more preferred ingredients selected from the group consisting of: polysaccharides; commercially available oligosaccharides; bleaching agents (bleach system); cellulase enzymes and mixtures thereof as described hereinabove. More preferably, the laundry and/or fabric care compositions further comprise one or more other cleaning adjunct materials as described hereinabove.

A highly preferred embodiment of the present invention is a laundry and/or fabric care composition comprising a combination of a XET enzyme and a polysaccharide, preferably a xyloglucan polymer, and optionally, a bleach system and/or cellulase enzyme.

It is desirable that the XET enzyme is present in the laundry and/or fabric care composition of the present invention in an amount in the range of from about 0.001% to about 25% by weight of the laundry and/or fabric care composition, more preferably from about 0.1% to about 10% by weight of the laundry and/or fabric care composition. Furthermore, it is desirable that the XET enzyme is present in the wash, soaking and/or spray-treatment solution in amount in the range of from about 0.02 ppm to about 2500 ppm, more preferably from about 0.1 ppm to about 500 ppm.

Preferably, the polysaccharide, when present, is present in the laundry and/or fabric care composition of the present invention in an amount in the range of from about 0.1% to about 50% by weight of the laundry and/or fabric care composition, more preferably from about 0.2% to about 25% by weight of the laundry and/or fabric care composition. Furthermore, it is desirable that the polysaccharide, when present, is present in the wash, soaking and/or spray-treatment solution in amount in the range of from about 0.1 ppm to about 25 ppm, more preferably from about 0.5 ppm to about 10 ppm.

Preferably, the oligosaccharide, when present, is present in the laundry and/or fabric care composition of the present invention in an amount in the range of from about 0.1% to about 50% by weight of the laundry and/or fabric care composition, more preferably from about 0.2% to about 25% by weight of the laundry and/or fabric care composition. Furthermore, it is desirable that the oligosaccharide, when present, is present in the wash, soaking and/or spray-treatment solution in amount in the range of from about 0.1 ppm to about 25 ppm, more preferably from about 0.5 ppm to about 10 ppm.

Preferably, the weight ratio of XET to polysaccharide and/or oligosaccharide is from about 1:100 to about 1:100,000, more preferably from about 1:1000 to about 1:10,000, most preferably from about 1:1000 to about 1:2500.

The laundry and/or fabric care compositions of the present invention are useful in the methods of treating fabric as described herein.

A preferred embodiment of the present invention is a method for treating a fabric in need of treatment during machine-washing of the fabric, wherein the method comprises treating in an automatic washing machine the fabric in need of treatment by contacting the fabric with a solution containing an effective amount laundry and/or fabric care composition of the present invention. The laundry and/or fabric care composition of the present invention comprising a combination of XET and a polysaccharide and/or oligosaccharide can be added as such as a pre-soak agent or to the wash solution via a detergent composition, as a detergent additive or as a rinse additive. Preferably, this method comprises the steps of:

(a) depositing the fabric in need of treatment into a washing machine;

(b) depositing an effective amount of the laundry and/or fabric care composition of the present invention into the washing machine such that an aqueous solution of the laundry and/or fabric care composition of the present invention contacts the fabric; and

(c) operating the washing machine in its wash cycle for an effective amount of time such that the laundry and/or fabric care composition of the present invention treats the fabric.

An “effective amount of time” with respect to the machine-washing method means the amount of time required for the laundry and/or fabric care composition of the present invention to adequately treat a fabric such that the fabric acquires improved anti-shrinkage, anti-felting, anti-fuzz, anti-redeposition and/or color appearance properties. Such time can vary quite widely, however, a preferred range of time is from about 1 hr to about 3 hrs, more preferably from about 10 minutes to about 30 minutes.

The washing machine used in the method described herein can be any conventional washing machine known in the art. In addition, it can be a specially designed washing machine such as the washing machine described in U.S. Pat. No. 5,520,025 to Joo et al.

Another embodiment of the present invention is a method for treating a fabric in need of treatment, wherein the method comprises soaking the fabric in need of treatment in an aqueous solution containing an effective amount of the laundry and/or fabric care composition of the present invention for an effective amount of time. This method is particularly useful for providing dye-fixing benefits to a fabric in need of treatment when the fabric is pre-soaked (pre-treated) in the laundry and/or fabric care composition prior to washing, especially machine washing. Optionally, this method further comprises manually washing the fabric in need of treatment for an effective amount of time such that the aqueous solution containing the laundry and/or fabric care composition of the present invention further treats the fabric.

An “effective amount of time” with respect to the soaking method means the amount of time required for the laundry and/or fabric care composition of the present invention to adequately treat a fabric such that the fabric acquires improved anti-shrinkage, anti-felting, anti-fuzz, anti-redeposition and/or color appearance properties. Such time can vary quite widely, however, a preferred range of time is from about 1 hr to about 3 hrs, more preferably 10 min to about 30 min.

Yet another embodiment of the present invention is a method for treating a fabric in need of treatment, wherein the method comprises contacting the fabric in need of treatment with an effective amount of the laundry and/or fabric care composition of the present invention for an effective amount of time such that the laundry and/or fabric care composition treats the fabric wherein the methods for contacting the fabric include, but are not limited to, spraying on, rolling on, spreading on, rubbing on, brushing on and/or dipping the fabric into the laundry and/or fabric care composition of the present invention or solution containing the composition, and any other suitable methods known in the art.

An “effective amount of time” with respect to these methods of contacting the fabric with the laundry and/or fabric care composition of the present invention means the amount of time required for the laundry and/or fabric care composition of the present invention to adequately treat a fabric such that the fabric acquires improved anti-shrinkage, anti-felting, anti-fuzz, anti-redeposition and/or color appearance properties. Such time can vary quite widely, however, a preferred range of time is from about 1 hr to about 3 hrs, more preferably 10 min to about 30 min.

Typical usage compositions for a dipping and/or soaking treatment contain a level of the laundry and/or fabric care composition of the present invention of from about 0.001% to about 2%, preferably from about 0.05% to about 1%, more preferably from about 0.1% to about 0.5%, by weight of the usage composition. However, it is also common and more practical to provide a more concentrated composition containing typically from about 0.5% to about 40%, preferably from about 1% to about 25%, more preferably from about 2% to about 15%, by weight of the concentrated composition, of the laundry and/or fabric care composition, to be diluted down in use to obtain the desirable usage dipping or soaking composition. A concentrated composition can also be used, and is provided, e.g., as a refill, to prepare usage composition for the spray product.

The laundry and/or fabric care composition of the present invention can include in addition to the preferred cleaning adjunct materials described above, other cleaning adjunct materials, such as one or more of the following ingredients selected from the group consisting of surfactants, builders, chelating agents, sources of other enzymatic activities (i.e., other enzymes), enzyme stabilizing systems, soil release/removal agents, suds suppressors, polyacids, anti-redeposition agents, hydrotropes, opacifiers, antioxidants, bactericides, dyes, perfumes, carriers and brighteners. Examples of such ingredients are generally described in U.S. Pat. No. 5,576,282.

Non-aqueous based heavy duty laundry detergent compositions containing the laundry and/or fabric care composition of the present invention preferably comprise from about 55% to about 98.9% by weight of the detergent composition of a structured, surfactant-containing liquid phase formed by combining:

(a) from about 1% to about 80% by weight of the liquid phase of one or more non-aqueous organic diluents; and

(b) from about 20% to about 99% by weight of the liquid phase of a surfactant system comprising surfactants selected from the group consisting of anionic, nonionic, cationic surfactants and mixtures thereof.

Aqueous based heavy duty laundry detergent compositions containing the laundry and/or fabric care composition of the present invention preferably contain a surfactant system comprising surfactants selected from the group consisting of nonionic detersive surfactants, anionic detersive surfactants, zwitterionic detersive surfactants, amine oxide detersive surfactants and mixtures thereof. The surfactant system typically comprises from about 0.01% to about 50%, preferably from about 0.2% to about 30% by weight of the detergent composition

Alternatively, the laundry and/or fabric care compositions of the present invention can be incorporated into a spray dispenser, or concentrated stick form that can create an article of manufacture that can facilitate the cleaning and/or fabric care or conditioning of fabric. If the spray treatment is a “pretreat”, which is followed by a wash cycle, then the spray treatment laundry and/or fabric care compositions preferably comprise from about 0.01% to about 50% of the combination of XET and polysaccharide and/or oligosaccharide by weight the of total laundry and/or fabric care composition, more preferably from about 1% to about 10% of the combination of XET and polysaccharide and/or oligosaccharide by weight of the total laundry and/or fabric care composition. If the spray treatment compositions are desired to do the cleaning, as in the case of wash, then the spray treatment compositions preferably comprise from about 2 ppm to about 2500 ppm of the combination of XET and polysaccharide and/or oligosaccharide by weight of the total laundry and/or fabric care composition, more preferably from about 200 ppm to about 500 ppm of the combination of XET and polysaccharide and/or oligosaccharide by weight of the total laundry and/or fabric care composition. In the latter case, a brief rinse, not a full wash cycle, is desirable after treatment. Such spray treatment compositions are typically packaged in a spray dispenser to create an article of manufacture that can facilitate treatment of fabric articles and/or surfaces with said laundry and/or fabric care compositions containing the combination of XET and polysaccharide and/or oligosaccharide improving active and other optional ingredients at a level that is effective, yet is not discernible when dried on the surfaces.

All these methods of contacting the fabric in need of treatment with the laundry and/or fabric care composition of the present invention preferably further include a drying step, if needed, after the contacting step has been completed.

Additionally, the laundry and/or fabric care compositions of the present invention can also be used as detergent additives. Such additives are intended to supplement or boost the performance of conventional detergent compositions.

Forms of Compositions

The laundry and/or fabric care compositions of the present invention can be in solid, liquid, paste, gel, spray, or foam forms.

The liquid forms can also be in a “concentrated” form which are diluted to form compositions with the usage concentrations, as given hereinabove, for use in the “usage conditions”. Concentrated compositions comprise a higher level of the combination of XET and polysaccharide and/or oligosaccharide, typically from about 1% to about 99%, preferably from about 2% to about 65%, more preferably from about 3% to about 25%, by weight of the concentrated laundry and/or fabric care composition. Concentrated compositions are used in order to provide a less expensive product. When a concentrated product is used, i.e., when the fabric improving active (the combination of XET and polysaccharide and/or oligosaccharide) is from about 1% to about 99%, by weight of the concentrated composition, it is preferable to dilute the composition, preferably with water, before treating a fabric in need of treatment. Preferably, the water content of the “concentrated” form is less than 40%, more preferably less than 30%, most preferably less than 20% by weight of the laundry and/or fabric care composition.

The present invention also relates to laundry and/or fabric care compositions of the present invention incorporated into a spray dispenser to create an article of manufacture that can facilitate treatment of fabric articles and/or surfaces with said compositions containing the combination of XET and polysaccharide and/or oligosaccharide and other optional ingredients at a level that is effective, yet is not discernible when dried on the surfaces. The spray dispenser comprises manually activated and non-manual powered (operated) spray means and a container containing the laundry and/or fabric care composition. The articles of manufacture preferably are in association with instructions for use to ensure that the consumer applies sufficient laundry and/or fabric care composition of the present invention to provide the desired benefit.

Typical compositions to be dispensed from a sprayer contain a level of the combination of XET and polysaccharide and/or oligosaccharide of from about 0.01% to about 5%, preferably from about 0.05% to about 2%, more preferably from about 0.1% to about 1%, by weight of the usage composition.

For wash-added and rinse-added methods, the article of manufacture can simply comprise a liquid or granular solid laundry and/or fabric care composition of the present invention and a suitable container.

Wash-added compositions, including liquid and granular detergent compositions and wash additive compositions typically contain a level of the combination of XET and polysaccharide and/or oligosaccharide of from about 0.2% to about 30%, preferably from about 1% to about 20%, more preferably from about 2% to about 12%, by weight of the wash added compositions.

Typical rinse-added compositions, including liquid fabric conditioner and other rinse additive compositions, contain a level of crude cotyledon extract of from about 0.3% to about 40%, preferably from about 1% to about 25%, more preferably from about 3% to about 15%, by weight of the rinse added compositions.

Preferably the articles of manufacture are in association with instructions for how to use the composition to treat fabrics correctly, to obtain the desirable fabric care results, viz, improved anti-wrinkle and/or shape retention and/or anti-shrinkage and/or tensile strength and/or color appearance and/or anti-bobbling and/or better static control, fabric softness, anti-wear properties and benefits, while at the same time providing improved cleaning benefits, including, e.g., the manner and/or amount of composition to be used, and the preferred ways of stretching and/or smoothing, if any, the fabrics. It is important that the instructions be as simple and clear as possible. Accordingly, the use of pictures and/or icons to assist in explaining the instructions is desirable.

Aqueous or solid, preferably powder, laundry and/or fabric care composition of the present invention for treating fabric in the rinse step in accordance with the present invention comprise an effective amount of the combination of XET and polysaccharide and/or oligosaccharide, and optionally, fabric softener actives, perfume, electrolytes, chlorine scavenging agents, dye transfer inhibiting agents, dye fixative agents, phase stabilizers, chemical stabilizers including antioxidants, silicones, antimicrobial actives and/or preservatives, chelating agents, aminocarboxylate chelating agents, colorants, enzymes, brighteners, soil release agents, or mixtures thereof. Again, the composition is preferably packaged in association with instructions for use to ensure that the consumer knows what benefits can be achieved.

Yet another aqueous or solid, preferably powder or granular, laundry and/or fabric care composition in accordance with the present invention to be used in the wash cycle comprises an effective amount of the combination of XET and polysaccharide and/or oligosaccharide, and optionally, surfactants, builders, perfume, chlorine scavenging agents, dye transfer inhibiting agents, dye fixative agents, dispersants, detergent enzymes, heavy metal chelating agents, suds suppressors, fabric softener actives, chemical stabilizers including antioxidants, silicones, antimicrobial actives and/or preservatives, soil suspending agents, soil release agents, optical brighteners, colorants, and the like, or mixtures thereof. Again, the composition is preferably packaged in association with instructions for use to ensure that the consumer knows what benefits can be achieved.

A preferred fabric care composition for treating fabric comprises an effective amount of the combination of XET and polysaccharide and/or oligosaccharide, and optionally, perfume, fabric lubricants, adjunct fabric shape retention polymers, lithium salts, hydrophilic plasticizers, odor control agents, antimicrobial actives and/or preservatives, surfactants, enzymes, or mixtures thereof. Other optional ingredients can also be added, e.g., antioxidants, chelating agents, e.g., aminocarboxylate chelating agents, heavy metal chelating agents, antistatic agents, insect and moth repelling agents, dye transfer inhibiting agents, dye fixative agents, colorants, suds suppressors, and the like, and mixtures thereof. The composition is typically applied to fabric via a, e.g., dipping, soaking and/or spraying process followed by a drying step, including the process comprising a step of treating or spraying the fabric with the fabric care composition either outside or inside an automatic clothes dryer followed by, or concurrently with, the drying step in said clothes dryer. The application can be done industrially by large scale processes on textiles and/or finished garments and clothings, or in consumer's home by the use of commercial product.

In addition to the methods for treating fabrics in need of treatment and other surfaces, described herein, the invention herein also encompasses a laundering pretreatment process for fabrics which have been soiled or stained comprising directly contacting said stains and/or soils with a highly concentrated form of the laundry and/or fabric care composition of the present invention, in any form, preferably a concentrated liquid (preferably in a spray dispenser or roll-on device), stick or bar, set forth above prior to washing such fabrics using conventional aqueous washing solutions. Preferably, the cleaning composition remains in contact with the soil/stain for a period of from about 30 seconds to 24 hours prior to washing the pretreated soiled/stained substrate in conventional manner. More preferably, pretreatment times will range from about 1 to 180 minutes.

The detergent compositions herein can be made by any suitable process known in the art. Examples of such processes are described in U.S. Pat. No. 5,576,282.

The detergent compositions herein will preferably be formulated such that, during use in aqueous cleaning operations, the wash water will have a pH of between about 6.5 and about 11, preferably between about 7.5 and 11. Techniques for controlling pH at recommended usage levels include the use of buffers, alkalis, acids, etc., and are well known to those skilled in the art.

Spray-Treatment Compositions

The spray-treatment compositions herein are typically packaged in spray dispensers. The spray dispensers can be any of the manually activated means for producing a spray of liquid droplets as is known in the art, e.g. trigger-type, pump-type, non-aerosol self-pressurized, and aerosol-type spray means. It is preferred that at least about 70%, more preferably, at least about 80%, most preferably at least about 90% of the droplets have a particle size of smaller than about 200 microns.

The spray dispenser can be an aerosol dispenser. Said aerosol dispenser comprises a container which can be constructed of any of the conventional materials employed in fabricating aerosol containers. The dispenser must be capable of withstanding internal pressure in the range of from about 20 to about 110 p.s.i.g., more preferably from about to about 70 p.s.i.g. The one important requirement concerning the dispenser is that it be provided with a valve member which will permit the laundry and/or fabric care compositions of the present invention contained in the dispenser to be dispensed in the form of a spray of very fine, or finely divided, particles or droplets. A more complete description of commercially available suitable aerosol spray dispensers appears in U.S. Pat. Nos.: 3,436,772, Stebbins, issued Apr. 8, 1969; and 3,600,325, Kaufman et al., issued Aug. 17, 1971.

Preferably the spray dispenser is a self-pressurized non-aerosol container having a convoluted liner and an elastomeric sleeve. A more complete description of suitable self-pressurized spray dispensers can be found in U.S. Pat. Nos.: 5,111,971, Winer, issued May 12, 1992; and 5,232,126, Winer, issued Aug. 3, 1993. Another type of suitable aerosol spray dispenser is one wherein a barrier separates the wrinkle reducing composition from the propellant (preferably compressed air or nitrogen), as is disclosed in U.S. Pat. No. 4,260,110, issued Apr. 7, 1981, incorporated herein by reference. Such a dispenser is available from EP Spray Systems, East Hanover, N.J.

More preferably, the spray dispenser is a non-aerosol, manually activated, pump-spray dispenser. A more complete disclosure of commercially available suitable dispensing devices appears in: U.S. Pat. Nos.: 4,895,279, Schultz, issued Jan. 23, 1990; 4,735,347, Schultz et al., issued Apr. 5, 1988; and 4,274,560, Carter, issued Jun. 23, 1981.

Most preferably, the spray dispenser is a manually activated trigger-spray dispenser. A more complete disclosure of commercially available suitable dispensing devices appears in U.S. Pat. Nos.: 4,082,223, Nozawa, issued Apr. 4, 1978; 4,161,288, McKinney, issued Jul. 7, 1985; 4,434,917, Saito et al., issued Mar. 6, 1984; and 4,819,835, Tasaki, issued Apr. 11, 1989; 5,303,867, Peterson, issued Apr. 19, 1994.

A broad array of trigger sprayers or finger pump sprayers are suitable for use with the compositions of this invention. These are readily available from suppliers such as Calmar, Inc., City of Industry, California; CSI (Continental Sprayers, Inc.), St. Peters, Missouri; Berry Plastics Corp., Evansville, Ind.—a distributor of Guala (sprayers; or Seaquest Dispensing, Cary, Ill.

The preferred trigger sprayers are the blue inserted Guala® sprayer, available from Berry Plastics Corp., the Calmar TS800-1A® sprayers, available from Calmar Inc., or the CSI T7500® available from Continental Sprayers Inc., because of the fine uniform spray characteristics, spray volume and pattern size. Any suitable bottle or container can be used with the trigger sprayer, the preferred bottle is a 17 fl-oz. bottle (about 500 ml) of good ergonomics similar in shape to the Cinch® bottle. It can be made of any materials such as high density polyethylene, polypropylene, polyvinyl chloride, polystyrene, polyethylene terephthalate, glass or any other material that forms bottles. Preferably, it is made of high density polyethylene or polyethylene terephthalate.

For smaller four fl-oz size (about 118 ml), a finger pump can be used with canister or cylindrical bottle. The preferred pump for this application is the cylindrical Euromist II® from Seaquest Dispensing.

Product/Instructions—This invention also encompasses the inclusion of instructions on the use of the laundry and/or fabric care compositions of the present invention with the packages containing the laundry and/or fabric care compositions herein or with other forms of advertising associated with the sale or use of the laundry and/or fabric care compositions. The instructions may be included in any manner typically used by consumer product manufacturing or supply companies. Examples include providing instructions on a label attached to the container holding the composition; on a sheet either attached to the container or accompanying it when purchased; or in advertisements, demonstrations, and/or other written or oral instructions which may be connected to the purchase of the laundry and/or fabric care compositions.

The instructions, for instance, may include information relating to the temperature of the wash water; washing time; recommended settings on the washing machine; recommended amount of the laundry and/or fabric care composition to use; pre-soaking procedures; and spray-treatment procedures.

A product comprising a laundry and/or fabric care composition of the present invention, the product further including instructions for using the laundry and/or fabric care composition to treat a fabric in need of treatment, the instructions including the step of: contacting said fabric with an effective amount of said laundry and/or fabric care composition for an effective amount of time such that said composition treats said fabric.

The product may be a laundry detergent composition, a fabric care composition or fabric conditioner. Furthermore, the product may be contained in a spray dispenser.

The following examples are meant to exemplify compositions of the present invention, but are not necessarily meant to limit or otherwise define the scope of the invention. In the detergent compositions, the enzyme levels are expressed by percent of pure enzyme by weight of the total composition and unless otherwise specified, the detergent ingredients are expressed as percent of detergent ingredients by weight of the total compositions.

Further, in the following examples some abbreviations known to those of ordinary skill in the art are used, consistent with the disclosure set forth herein, and/or are defined in below.

| | |
|---|---|
| LAS | : Sodium linear C₁₂ alkyl benzene sulphonate |
| TAS | : Sodium tallow alkyl sulphate |
| CXYAS | : Sodium C_{1X}—C_{1Y} alkyl sulfate |
| 25EY | : A C₁₂—C₁₅ predominantly linear primary alcohol condensed |
| | with an average of Y moles of ethylene oxide |
| CXYEZ | : A C_{1X}—C_{1Y} predominantly linear primary alcohol condensed |
| | with an average of Z moles of ethylene oxide |
| XYEZS | : C_{1X}—C_{1Y} sodium alkyl sulfate condensed with an average of |
| | Z moles of ethylene oxide per mole |
| QAS | : R₂.N⁺(CH₃)₂(C₂H₄OH) with R_{2 =}C₁₂—C₁₄ |
| Soap | : Sodium linear alkyl carboxylate derived from a 80/20 mixture |
| | of tallow and coconut oils. |
| Nonionic | : C₁₃—C₁₅ mixed ethoxylated/propoxylated fatty alcohol with |
| | an average degree of ethoxylation of 3.8 and an average degree |
| | of propoxylation of 4.5 sold under the tradename Plurafac |
| | LF404 by BASF Gmbh. |
| CFAA | : C₁₂—C₁₄ alkyl N-methyl glucamide |
| TFAA | : C₁₆—C₁₈ alkyl N-methyl glucamide |
| TPKFA | : C12—C14 topped whole cut fatty acids. |
| DEQA | : Di-(tallow-oxy-ethyl) dimethyl ammonium chloride. |
| Neodol 45-13 | : C14—C15 linear primary alcohol ethoxylate, sold by Shell |
| | Chemical CO. |
| Silicate | : Amorphous Sodium Silicate (Si0₂:Na₂O ratio = 2.0) |
| NaSKS-6 | : Crystalline layered silicate of formula δ-Na₂Si₂O₅. |
| Carbonate | : Anhydrous sodium carbonate with a particle size between |
| | 200 μm and 900 μm. |
| Bicarbonate | Anhydrous sodium bicarbonate with a particle size between |
| | 400 μm and 1200 μm. |
| STPP | : Anhydrous sodium tripolyphosphate |
| MA/AA | : Copolymer of 1:4 maleic/acrylic acid, average molecular |
| | weight about 70,000-80,000 |
| Zeolite A | : Hydrated Sodium Aluminosilicate of formula |
| | Na₁₂(AlO₂SiO₂)₁₂ |
| | .27H₂O having a primary particle size in the range from |
| | 0.1 to 10 micrometers |
| Citrate | : Tri-sodium citrate dihydrate of activity 86.4% with a |
| | particle size distribution between 425 μm and 850 μm. |
| Citric | : Anhydrous citric acid |
| PB1 | : Anhydrous sodium perborate monohydrate bleach, empirical |
| | formula NaBO₂.H₂O₂ |
| PB4 | : Anhydrous sodium perborate tetrahydrate |
| Percarbonate | : Anhydrous sodium percarbonate bleach of empirical formula |
| | 2Na₂CO₃.3H₂O₂ |
| TAED | : Tetraacetyl ethylene diamine. |
| NOBS | : Nonanoyloxybenzene sulfonate in the form of the sodium salt. |
| Photoactivated Bleach | : Sulfonated zinc phtalocyanine encapsulated in dextrin soluble |
| | polymer. |
| Protease | : Proteolytic enzyme sold under the tradename Savinase, |
| | Alcalase, Durazym by Novo Nordisk A/S. Maxacal, Maxapem |
| | sold by Gist-Brocades and proteases described in patents |
| | WO91/06637 and/or WO95/10591 and/or EP 251 446. |
| Amylase | : Amylolytic enzyme sold under the tradename Purafact Ox |
| | Am^{R} described in WO 94/18314, WO96/05295 sold by |
| | Genencor; |
| | Termamyl ®, Fungamyl ® and Duramyl ®, all available from |
| | Novo Nordisk A/S and those described in WO95/26397. |
| Lipase | : Lipolytic enzyme sold under the tradename Lipolase, |
| | Lipolase Ultra by Novo Nordisk A/S |
| Cellulase | : Cellulytic enzyme sold under the tradename Carezyme, |
| | Celluzyme and/or Endolase by Novo Nordisk A/S. |
| CMC | : Sodium carboxymethyl cellulose. |
| HEDP | : 1,1-hydroxyethane diphosphonic acid. |
| DETPMP | : Diethylene triamine penta (methylene phosphonic acid), |
| | marketed by Monsanto under the Trade name Dequest 2060. |
| PVNO | : Poly (4-vinylpyridine)-N-Oxide. |
| PVPVI | : Poly (4-vinylpyridine)-N-oxide/copolymer of vinyl-imidazole |
| | and vinyl-pyrrolidone. |
| Brightener 1 | : Disodium 4,4′-bis(2-sulphostyryl)biphenyl. |
| Brightener 2 | : Disodium 4,4′-bis(4-anilino-6-morpholino-1.3.5-triazin-2-yl) |
| | stilbene-2:2′-disulfonate. |
| Silicone antifoam | : Polydimethylsiloxane foam controller with siloxane- |
| | oxyalkylene copolymer as dispersing agent with a ratio of |
| | said foam controller to said dispersing agent of 10:1 to |
| | 100:1. |
| Granular Suds | : 12% Silicone/silica, 18% stearyl alcohol,70% starch in |
| Suppressor | granular form |
| SRP 1 | : Sulfobenzoyl or sodium isethionate end capped esters with |
| | oxyethylene oxy and terephtaloyl backbone. |
| SRP 2 | : Diethoxylated poly (1,2 propylene terephtalate) short block |
| | polymer. |
| Sulphate | : Anhydrous sodium sulphate. |
| HMWPEO | : High molecular weight polyethylene oxide |

### EXAMPLE I

| | Ia | Ib | Ic | Id | Ie | If |
|---|---|---|---|---|---|---|
| Ingredients | Wt. % | Wt. % | Wt. % | Wt. % | Wt. % | Wt. % |
| XET | 1 | 0.5 | 0.001 | 10 | 0.1 | 2 |
| Polysaccharide | 0.1 | — | 0.5 | — | 10 | 5 |
| Oligosaccharide | — | 1 | — | 10 | — | 2 |
| Volatile Perfume A⁽¹⁾ | — | — | — | 0.1 | — | — |
| Substantive Perfume B⁽²⁾ | — | — | — | — | 0.03 | — |
| Hydrophilic Perfume C⁽³⁾ | — | — | — | — | — | 0.05 |
| Polysorbate 60⁽⁴⁾ | — | — | — | 0.2 | 0.1 | — |
| Kathon CG | 3 ppm | 3 ppm | 3 ppm | 3 ppm | 3 ppm | 3 ppm |
| Deionized Water | Bal. | Bal. | Bal. | Bal. | Bal. | Bal. |

⁽¹⁾Perfume contains mainly ingredients having a boiling point of less than about 250° C.
⁽²⁾Perfume contains mainly ingredients having a boiling point of about 250° C. or higher.
⁽³⁾Perfume contains mainly ingredients having a ClogP of about 3.0 or less.
⁽⁴⁾A mixture of stearate esters of sorbitol and sorbitol anhydride, consisting predominantly of the monoester, condensed with about 20 moles of ethylene oxide.

### EXAMPLE II

| | IIa | IIb | Iic | Iid | Iie | IIf |
|---|---|---|---|---|---|---|
| Ingredients | Wt. % | Wt. % | Wt. % | Wt. % | Wt. % | Wt. % |
| XET | 3 | 7 | 0.5 | 1 | 2 | 0.05 |
| Polysaccharide | 0.2 | — | 10 | — | 7 | 20 |
| Oligosaccharide | — | 3 | — | 7 | — | 1 |
| Perfume A | — | — | — | — | 1 | — |
| Perfume B | — | — | — | 0.3 | — | — |
| Perfume C | — | — | — | — | — | 1.5 |
| Polysorbate 60 | — | — | — | 0.5 | 1.5 | 1 |
| Kathon CG | 3 ppm | 3 ppm | 3 ppm | 3 ppm | 3 ppm | 3 ppm |
| Deionized Water | Bal. | Bal. | Bal. | Bal. | Bal. | Bal. |

Concentrated compositions of Examples II are diluted with water to obtain usage compositions for, e.g., spraying, soaking, dipping, cellulosic fabrics.

### EXAMPLE III

| | IIIa | IIIb | IIIc | IIId | IIIe |
|---|---|---|---|---|---|
| Ingredients | Wt. % | Wt. % | Wt. % | Wt. % | Wt. % |
| XET | 10 | 3 | 0.9 | 0.03 | 2 |
| Polysaccharide | 1 | — | 3 | — | 0.5 |
| Oligosaccharide | — | 2 | — | 20 | 9 |
| LiBr | 3 | — | — | 2 | 2 |
| Silicone Emulsion A⁽⁵⁾ | — | 1.5 | — | — | 2.0 |
| D5 Volatile Silicone | — | — | 0.5 | 0.5 | — |
| Perfume A | — | — | — | — | 0.03 |
| Perfume B | — | — | — | 0.05 | — |
| Perfume C | 0.03 | — | — | — | — |
| Polysorbate 60 | — | — | — | 0.1 | 0.05 |
| Silwet L-7602 | — | — | — | 0.5 | — |
| Silwet L-7622 | — | — | — | — | 0.3 |
| Kathon CG | 3 ppm | 3 ppm | 3 ppm | 3 ppm | 3 ppm |
| Deionized Water | Bal. | Bal. | Bal. | Bal. | Bal. |

⁽⁵⁾DC-2-5932 silicone microemulsion (25% active) from Dow Corning, with a particle size of about 24 nm, a cationic surfactant system, and a silicone with an internal phase viscosity of about 1,200 cps.

### EXAMPLE IV

| | IVa | IVb | IVc | IVd | IVe | IVf |
|---|---|---|---|---|---|---|
| Ingredients | Wt. % | Wt. % | Wt. % | Wt. % | Wt. % | Wt. % |
| XET | 0.1 | 8 | 0.005 | 3 | 1 | 22 |
| Polysaccharide | 5 | — | 30 | — | 1 | 0.1 |
| Oligosaccharide | — | 0.5 | — | 5 | — | 1 |
| Copolymer A⁽⁶⁾ | 0.4 | — | — | — | — | 0.5 |
| Copolymer B⁽⁷⁾ | — | 0.5 | — | 0.3 | — | — |
| Copolymer C⁽⁸⁾ | — | — | 0.6 | — | 0.5 | — |
| LiBr | — | — | — | 3 | — | 2 |
| Silicone Emulsion A⁽⁵⁾ | — | — | — | — | 1.5 | — |
| D5 Volatile Silicone | — | — | — | — | — | 0.5 |
| Perfume A | 0.06 | — | — | — | — | 0.07 |
| Perfume B | — | 0.03 | — | 0.03 | — | — |
| Perfume C | — | — | 0.04 | — | 0.03 | — |
| Polysorbate 60 | 0.1 | 0.1 | 0.03 | 0.1 | 0.1 | 0.1 |
| Silwet L-7600 | — | — | — | 0.5 | — | — |
| Silwet L-7602 | — | — | — | — | — | 0.7 |
| Kathon CG | 3 ppm | 3 ppm | 3 ppm | 3 ppm | 3 ppm | 3 ppm |
| Deionized Water | Bal. | Bal. | Bal. | Bal. | Bal. | Bal. |

⁽⁵⁾DC-2-5932 silicone microemulsion (25% active) from Dow Corning, with a particle size of about 24 nm, a cationic surfactant system, and a silicone with an internal phase viscosity of about 1,200 cps.
⁽⁶⁾Acrylic acid/tert-butyl acrylate copolymer, with an approximate acrylic acid/tert-butyl acrylate weight ratio of about 25/75 and an average molecular weight of from about 70,000 to about 100,000.
⁽⁷⁾Acrylic acid/tert-butyl acrylate copolymer, with an approximate acrylic acid/tert-butyl acrylate weight ratio of about 35/65 and an average molecular weight of from about 60,000 to about 90,000.
⁽⁸⁾Acrylic acid/tert-butyl acrylate copolymer, with an approximate acrylic acid/tert-butyl acrylate weight ratio of about 20/80 and an average molecular weight of from about 80,000 to about 110,000.

### EXAMPLE V

| | Va | Vb | Vc | Vd | Ve | Vf |
|---|---|---|---|---|---|---|
| Ingredients | Wt. % | Wt. % | Wt. % | Wt. % | Wt. % | Wt. % |
| XET | 0.001 | 5 | 2 | 15 | 25 | 0.5 |
| Polysaccharide | 40 | — | 10 | — | 0.4 | 7 |
| Oligosaccharide | — | 2 | — | 0.8 | — | 1 |
| Copolymer D⁽⁹⁾ | 0.4 | — | — | — | 2 | 0.25 |
| Copolymer E⁽¹⁰⁾ | — | 0.5 | — | — | — | 0.25 |
| Copolymer F⁽¹¹⁾ | — | — | 0.4 | — | — | — |
| Copolymer G⁽¹²⁾ | — | — | — | 0.5 | — | — |
| D5 Volatile Silicone | — | 0.25 | — | — | — | — |
| PDMS 10,000 cst | — | — | — | 0.3 | — | — |
| Silicone Emulsion | — | — | 1 | — | 2 | — |
| B⁽¹³⁾ | | | | | | |
| Perfume A | 0.06 | — | — | — | — | 0.07 |
| Perfume B | — | 0.03 | — | 0.03 | — | — |
| Perfume C | — | — | 0.04 | — | 0.5 | — |
| Polysorbate 60 | 0.1 | 0.1 | — | 0.1 | 0.5 | 0.1 |
| Neodol 23-3 | — | 0.25 | — | 0.2 | — | — |
| Neodol 25-3 | — | — | 0.3 | — | 0.3 | 0.25 |
| Silwet L-77 | — | 0.7 | — | 1 | — | — |
| Silwet L-7604 | — | — | 0.5 | — | — | 0.7 |
| Kathon CG | 3 ppm | 3 ppm | 3 ppm | 3 ppm | 3 ppm | 3 ppm |
| Deionized Water | Bal. | Bal. | Bal. | Bal. | Bal. | Bal. |

⁽⁹⁾Acrylic acid/tert-butyl acrylate copolymer, with an approximate acrylic acid/tert-butyl acrylate weight ratio of about 23/77 and an average molecular weight of about 82,000.
⁽¹⁰⁾Silicone-containing copolymer having t-butyl acrylate/acrylic acid/(polydimethylsiloxane macromer, 10,000 approximate molecular weight) monomer at an approximate 63/20/17 weight ratio, and of an average molecular weight of about 130,000.
⁽¹¹⁾Silicone-containing copolymer having t-butylacrylate/acrylic acid/(polydimethylsiloxane macromer, 10,000 approximate molecular weight) monomer at an approximate 65/25/10 weight ratio, and of average molecular weight of about 200,000.
⁽¹²⁾Silicone-containing copolymer having (N,N,N-trimethylammonioethyl methacrylate chloride)/N,N-dimethylacrylamide/(PDMS macromer - 15,000 approximate molecular weight) at an approximate 40/40/20 weight ratio, and of average molecular weight of about 150,000.
⁽¹³⁾DC-1550 silicone microemulsion (25% active) from Dow Corning, with a particle size of about 50 nm, an anionic/nonionic surfactant system, and a silicone with an internal phase viscosity of about 100,000 cps.
The composition of Example Ve is a concentrated composition, to be diluted for use.

### EXAMPLE VI

| | VIa | VIb | VIc | VId | VIe | VIf |
|---|---|---|---|---|---|---|
| Ingredients | Wt. % | Wt. % | Wt. % | Wt. % | Wt. % | Wt. % |
| XET | 2 | 1 | 10 | 0.5 | 0.08 | 0.003 |
| Polysaccharide | 1 | — | 0.7 | — | 10 | 15 |
| Oligosaccharide | — | 0.9 | — | 5 | — | 2 |
| HPBCD⁽¹⁴⁾ | 1 | — | 0.5 | — | 0.5 | — |
| RAMEB⁽¹⁵⁾ | — | 1 | — | — | — | — |
| HPACD⁽¹⁶⁾ | — | — | 0.5 | — | — | — |
| α-Cyclodextrin | — | — | — | — | 0.5 | 0.5 |
| β-Cyclodextrin | — | — | — | 0.5 | — | 0.5 |
| ZnCl₂ | — | 1.0 | — | 1.0 | — | 1 |
| Silwet L-7657 | — | — | — | — | 0.05 | — |
| Perfume C | 0.1 | 0.07 | 0.05 | — | 0.1 | 0.05 |
| Propylene glycol | 0.06 | — | 0.05 | — | 0.03 | — |
| Kathon CG | 3 ppm | 3 ppm | 3 ppm | 3 ppm | 3 ppm | 3 ppm |
| HCl | — | to pH 4.5 | — | to pH 5 | — | to pH 4.5 |
| Distilled water | Bal. | Bal. | Bal. | Bal. | Bal. | Bal. |

⁽¹⁴⁾Hydroxypropyl beta-cyclodextrin.
⁽¹⁵⁾Randomly methylated beta-cyclodextrin.
⁽¹⁶⁾Hydroxypropyl alpha-cyclodextrin.

### EXAMPLE VII

| | VIIa | VIIb | VIIc | VIId | VIIe | VIIf |
|---|---|---|---|---|---|---|
| Ingredients | Wt. % | Wt. % | Wt. % | Wt. % | Wt. % | Wt. % |
| XET | 1 | 5 | 0.2 | 0.005 | 2 | 3 |
| Polysaccharide | 5 | — | 7 | — | 0.7 | 1 |
| Oligosaccharide | — | 0.5 | — | 10 | — | 2 |
| HPBCD | 1.0 | — | — | — | — | — |
| RAMEB | — | 1.0 | — | — | — | — |
| Silwet L-7604 | 0.3 | 0.2 | 0.2 | — | — | 0.1 |
| Chlorhexidine | 0.01 | — | — | — | — | 0.005 |
| Barquat 4250⁽¹⁷⁾ | — | — | 0.03 | — | — | — |
| Bardac 2050⁽¹⁸⁾ | — | — | — | 0.03 | 0.03 | — |
| Perfume C | 0.08 | 0.08 | 0.05 | 0.05 | — | — |
| HCl | to pH 4 | — | — | — | — | — |
| Kathon CG | 3 ppm | 3 ppm | 3 ppm | 3 ppm | 3 ppm | 3 ppm |
| Distilled water | Bal. | Bal. | Bal. | Bal. | Bal. | Bal. |

⁽¹⁷⁾Benzalkonium chloride, 50% solution.
⁽¹⁸⁾Dioctyl dimethyl ammonium chloride, 50% solution.

onto clothing using, e.g., the TS-800 sprayer from Calmar, and allowed to evaporate off of the clothing.

The compositions of Examples I to VII (diluted when appropriate) are sprayed onto clothing using, e.g., the TS-800 sprayer from Calmar, and allowed to evaporate off of the clothing.

The compositions of Examples I to VII (diluted when appropriate) are sprayed onto clothing, using a blue inserted Guala® trigger sprayer, available from Berry Plastics Corp. and a cylindrical Euromist II® pump sprayer available from Seaquest Dispensing, respectively, and allowed to evaporate off of the clothing.

The compositions of Examples I to VII (diluted when appropriate) contained in rechargeable battery-operated Solo Spraystar sprayers are sprayed onto large surfaces of fabric, such as several pieces of clothing, and allowed to evaporate off of these surfaces. The level of coverage is uniform and the ease and convenience of application is superior to conventional manually operated trigger sprayers.

The compositions of Examples I to VII (diluted when appropriate) are used for soaking or dipping of fabrics which are then optionally wrung or squeezed to remove excess liquid and subsequently dried.

Following are Examples for rinse added fabric care compositions in accordance with the present invention:

### EXAMPLE VIII

| | VIIIa | VIIIb | VIIIc | VIIId | VIIIe |
|---|---|---|---|---|---|
| Ingredients | Wt. % | Wt. % | Wt. % | Wt. % | Wt. % |
| XET | 0.001 | 1 | 0.5 | 2 | 2 |
| Polysaccharide | 10 | — | 7 | — | 1 |
| Oligosaccharide | — | 5 | — | 15 | 2 |
| Fabric softener A⁽¹⁹⁾ | 4.5 | — | — | — | — |
| Fabric softener B⁽²⁰⁾ | — | 24 | — | — | — |
| Fabric softener C⁽²¹⁾ | — | — | 26 | — | — |
| Fabric softener D⁽²²⁾ | — | — | — | 28 | 28 |
| Fabric softener E⁽²³⁾ | 3.4 | — | — | — | — |
| 1,2-Hexanediol | — | — | 18 | — | — |
| 2-Ethyl-1,3-hexanediol | — | — | — | 6 | — |
| Neodol 91-8 | — | — | — | 5 | 3 |
| Pluronic L-350 | — | — | — | 1 | |
| Hexylene glycol | — | — | — | — | 3 |
| Hexylene glycol (from | — | — | — | 2.5 | 2.5 |
| softener active) | | | | | |
| Ethanol (from softener | — | 4.2 | 4.6 | 2.3 | 2.3 |
| active) | | | | | |
| Perfume B | 0.3 | 1.3 | 1.3 | 2 | 1.2 |
| Tenox 6 antioxidant | 0.02 | 0.04 | 0.04 | 0.04 | 0.04 |
| CaCl₂ | 0.05 | 0.4 | 0.5 | — | 2 |
| MgCl₂ | — | — | — | 1.6 | — |
| HCl | to pH 6 | to pH 3.5 | to pH 3.5 | to pH 3 | to pH 3 |
| Kathon CG | 3 ppm | 3 ppm | 3 ppm | 3 ppm | 3 ppm |
| Deionized water and | Bal. | Bal. | Bal. | Bal. | Bal. |
| other minor | | | | | |
| ingredients | | | | | |

⁽¹⁹⁾Di(hydrogenated tallowyl) dimethyl ammonium chloride/hydrogenated tallowyl trimethyl ammonium chloride blend of about 83:17 weight ratio.
⁽²⁰⁾Di(acyloxyethyl) dimethyl ammonium chloride wherein the acyl group is derived from soft tallow fatty acids and with a diester-to-monoester weight ratio of about 11:1.
⁽²¹⁾Di(acyloxyethyl) dimethyl ammonium chloride wherein the acyl group is derived from partially hydrogenated canola fatty acids and with a diester-to-monoester weight ratio of about 11:1.
⁽²²⁾Di(acyloxyethyl)(2-hydroxyethyl)methyl ammonium methyl sulfate wherein the acyl group is derived from partially hydrogenated canola fatty acids.
⁽²³⁾1-Tallow(amidoethyl)-2-tallowimidazoline.

### EXAMPLE IX

| | IXa | IXb | IXc | IXd | IXe | IXf |
|---|---|---|---|---|---|---|
| Ingredients | Wt. % | Wt. % | Wt. % | Wt. % | Wt. % | Wt. % |
| XET | 1 | 0.05 | 0.5 | 3 | 5 | 0.1 |
| Polysaccharide | 5 | — | 8 | — | 10 | 1 |
| Oligosaccharide | — | 2 | — | 5 | — | 1 |
| Fabric softener | 4.5 | — | — | — | — | — |
| A⁽¹⁹⁾ | | | | | | |
| Fabric softener | — | 22 | 25 | 25 | — | — |
| B⁽²⁰⁾ | | | | | | |
| Fabric softener | 3.4 | — | — | — | — | — |
| E⁽²³⁾ | | | | | | |
| PVP K-15⁽²⁴⁾ | 1 | 3 | — | — | 5 | — |
| PVNO⁽²⁵⁾ | — | — | 1 | — | — | — |
| Cellulase⁽²⁶⁾ | — | — | — | 1 | — | 2 |
| Perfume B | 0.4 | 1.3 | 1.3 | 1.3 | 2 | — |
| Perfume C | — | — | — | — | — | 1.5 |
| Polysorbate 60 | — | — | — | — | 5 | 1 |
| HCl | to pH 5 | to pH | to pH | to pH | — | — |
| | | 3.5 | 3.5 | 3.5 | | |
| Kathon CG | 3 ppm | 3 ppm | 3 ppm | 3 ppm | 3 ppm | 3 ppm |
| Deionized water | Bal. | Bal. | Bal. | Bal. | Bal. | Bal. |
| and minor | | | | | | |
| ingredients | | | | | | |

⁽¹⁹⁾Di(hydrogenated tallowyl) dimethyl ammonium chloride/hydrogenated tallowyl trimethyl ammonium chloride blend of about 83:17 weight ratio.
⁽²⁰⁾Di(acyloxyethyl) dimethyl ammonium chloride wherein the acyl group is derived from soft tallow fatty acids and with a diester-to-monoester weight ratio of about 11:1.
⁽²³⁾1-Tallow(amidoethyl)-2-tallowimidazoline.
⁽²⁴⁾Polyvinylpyrrolidone with an average molecular weight of about 10,000.
⁽²⁵⁾Poly(4-vinylpyridine-N-oxide) with an average molecular weight of about 25,000.
⁽²⁶⁾The cellulase consists essentially of a homogeneous endoglucanase component, which is immunoreactive with an antibody raised against a lightly purified 43 kD cellulase derived from Humicola insolens, DMS 1800, or which is homologous to said 43 kD endoglucanase; the cellulase solution used provides about 5,000 CEVU's per gram.

### EXAMPLE X

| | Xa | Xb |
|---|---|---|
| Ingredients | Wt % | Wt. % |
| LAS | 8 | 8 |
| C25E3 | 3.4 | 3.4 |
| QAS | — | 0.8 |
| Zeolite A | 17 | 17 |
| Carbonate | 13 | 24 |
| Silicate | 1.4 | 3 |
| Sulfate | 25 | 15 |
| PB4 | 9 | 8 |
| TAED | 1.5 | 1.5 |
| DETPMP | 0.25 | 0.25 |
| HEDP | 0.3 | 0.3 |
| XET | 0.1 | 2 |
| Polysaccharide | 2 | — |
| Oligosaccharide | — | 1 |
| Protease | 26 ppm | 26 ppm |
| MA/AA | 0.3 | 0.3 |
| CMC | 0.2 | 0.2 |
| Photoactivated Bleach | — | 10 ppm |
| Brightener | 0.09 | 0.09 |
| Perfume | 0.3 | 0.3 |
| Silicone antifoam | 0.5 | 0.5 |
| Moisture and Miscellaneous | Balance | Balance |

### EXAMPLE XI

Nil bleach-containing laundry detergent fabric care compositions of particular use in the washing of colored clothing:

| | XIa | Xib |
|---|---|---|
| Ingredients | Wt % | Wt. % |
| Blown Powder | | |
| Zeolite A | 14 | 14 |
| Sodium sulfate | — | 13 |
| LAS | 2.8 | 3 |
| DETPMP | 0.4 | 0.5 |
| CMC | 0.4 | 0.4 |
| MA/AA | 3.8 | 4 |
| Agglomerates | | |
| LAS | 5.5 | 5 |
| TAS | 3 | 2 |
| Silicate | 4 | 4 |
| Zeolite A | 9 | 13 |
| Carbonate | 9 | 7 |
| Spray On | | |
| Perfume | 0.3 | 0.3 |
| C45E7 | 4 | 4 |
| C25E3 | 1.8 | 1.8 |
| Dry additives | | |
| Citrate | 10 | — |
| Bicarbonate | 6.5 | 3 |
| Carbonate | 7.5 | 5 |
| PVPVI/PVNO | 0.5 | 0.5 |
| XET | 0.5 | 1 |
| Polysaccharide | 3 | — |
| Oligosaceharide | — | 5 |
| Protease | 0.026 | 0.016 |
| Lipase | 0.009 | 0.009 |
| Amylase | 0.005 | — |
| Cellulase | 0.006 | 0.006 |
| Silicone antifoam | 4 | 3 |
| Moisture and Miscellaneous | Balance | Balance |

### EXAMPLE XII

Examples of liquid detergent fabric care compositions according to the present invention:

| | XIIa | XIIb | XIIc | XIId | XIIe |
|---|---|---|---|---|---|
| Ingredients | Wt. % | Wt. % | Wt. % | Wt. % | Wt. % |
| LAS | 9 | 8 | — | 22 | — |
| C25AS | 4 | 2 | 9 | — | 12 |
| C25E3S | 1 | — | 3 | — | 3.5 |
| C25E7 | 6 | 12 | 2.5 | — | 3.5 |
| TFAA | — | — | 4.5 | — | 7.5 |
| QAS | — | — | — | 3 | — |
| TPKFA | 2 | 12 | 2 | — | 5.5 |
| Canola fatty acids | — | — | 5 | — | 4 |
| Citric | 2 | 1 | 1.5 | 1 | 1 |
| Dodecenyl/ | 10 | — | — | 14 | — |
| tetradecenyl | | | | | |
| succinic acid | | | | | |
| Oleic acid | 4 | 1 | — | 1 | — |
| Ethanol | 4 | 6 | 2 | 6 | 2 |
| 1,2 Propanediol | 4 | 2 | 6 | 6 | 10 |
| Mono Ethanol Amine | — | — | 5 | — | 8 |
| Tri Ethanol Amine | — | 7 | — | — | — |
| NaOH (pH) | 8 | 7.5 | 7.5 | 8 | 8 |
| Ethoxylated | 0.5 | 0.5 | 0.2 | — | 0.3 |
| tetraethylene | | | | | |
| pentamine | | | | | |
| DETPMP | 1 | 0.5 | 1 | 2 | — |
| SRP 2 | 0.3 | 0.3 | 0.1 | — | 0.1 |
| PVNO | — | — | — | — | 0.1 |
| XET | 0.2 | 1 | 0.005 | 3 | 7 |
| Polysaccharide | 5 | — | 10 | — | 2 |
| Oligosaccharide | — | 5 | — | 10 | 1 |
| Protease | 50 ppm | 40 ppm | 30 ppm | 0.08 | 60 ppm |
| Lipase | — | — | 2 ppm | — | 30 ppm |
| Amylase | 20 ppm | 50 ppm | 40 ppm | 20 ppm | 50 ppm |
| Cellulase | — | — | 1 ppm | — | 4 ppm |
| Boric acid | 0.1 | — | 2 | 1 | 2.5 |
| Na formate | — | 1 | — | — | — |
| Ca chloride | — | — | 0.01 | — | — |
| Bentonite clay | — | — | — | 3.5 | — |
| Suspending clay SD3 | — | — | — | 0.6 | — |
| Water and | Bal. | Bal. | Bal. | Bal. | Bal. |
| Miscellaneous | | | | | |

### EXAMPLE XIII

Examples of syndet bar fabric detergent fabric care compositions in accord with the present invention:

| | XIVa | XIVb |
|---|---|---|
| Ingredients | Wt % | Wt. % |
| C26 AS | 18 | 18 |
| CFAA | 5 | 5 |
| LAS (C11-13) | 10 | 10 |
| Sodium carbonate | 22 | 25 |
| Sodium pyrophosphate | 6 | 6 |
| STPP | 6 | 6 |
| Zeolite A | 5 | 5 |
| CMC | 0.2 | 0.2 |
| Polyacrylate (MW 1400) | 0.2 | 0.2 |
| Coconut monoethanolamide | 5 | 5 |
| XET | 1 | 3 |
| Polysaccharide | 4 | — |
| Oligosaccharide | — | 2 |
| Amylase | — | 0.02 |
| Protease | — | 0.3 |
| Perfume | 0.2 | 0.2 |
| Brightener | 0.1 | 0.1 |
| CaSO4 | 1 | 1 |
| MgSO4 | 1 | 1 |
| Water | 4 | 4 |
| Filler* | Balance | Balance |

*Can be selected from convenient materials such as CaCO₃, talc, clay (Kaolinite, Smectite), silicates, and the like.

### EXAMPLE XIV

Examples of syndet bar fabric detergent fabric care compositions in accord with the present invention:

| | XIVa | XIVb |
|---|---|---|
| Ingredients | Wt % | Wt. % |
| C26 AS | 20.00 | 20.00 |
| CFAA | 5.0 | 5.0 |
| LAS (C11-13) | 10.0 | 10.0 |
| Sodium carbonate | 25.0 | 25.0 |
| Sodium pyrophosphate | 7.0 | 7.0 |
| STPP | 7.0 | 7.0 |
| Zeolite A | 5.0 | 5.0 |
| CMC | 0.2 | 0.2 |
| Polyacrylate (MW 1400) | 0.2 | 0.2 |
| Coconut monoethanolamide | 5.0 | 5.0 |
| XET | 0.001 | 0.7 |
| Polysaccharide | 20 | — |
| Oligosaccharide | — | 15 |
| Amylase | 0.01 | 0.02 |
| Protease | 0.3 | — |
| Brightener, perfume | 0.2 | 0.2 |
| CaSO4 | 1.0 | 1.0 |
| MgSO4 | 1.0 | 1.0 |
| Water | 4.0 | 4.0 |
| Filler*: balance to 100% | | |

### EXAMPLE XV

The following bleach-containing detergent formulations, according to the present invention, are prepared where XVa and XVc are phosphorus-containing detergent compositions, and XVb is a zeolite-containing detergent composition:

| | Xva | XVb | XVc |
|---|---|---|---|
| Blown Powder: | | | |
| STPP | 24.0 | — | 24.0 |
| Zeolite A | — | 24.0 | — |
| C45AS | 9.0 | 6.0 | 13.0 |
| MA/AA | 2.0 | 4.0 | 2.0 |
| LAS | 6.0 | 8.0 | 11.0 |
| TAS | 2.0 | — | — |
| Silicate | 7.0 | 3.0 | 3.0 |
| CMC | 1.0 | 1.0 | 0.5 |
| Brightener 2 | 0.2 | 0.2 | 0.2 |
| Soap | 1.0 | 1.0 | 1.0 |
| DETPMP | 0.4 | 0.4 | 0.2 |
| Spray On | | | |
| C45E7 | 2.5 | 2.5 | 2.0 |
| C25E3 | 2.5 | 2.5 | 2.0 |
| Silicone antifoam | 0.3 | 0.3 | 0.3 |
| Perfume | 0.3 | 0.3 | 0.3 |
| Dry additives: | | | |
| Carbonate | 6.0 | 13.0 | 15.0 |
| PB4 | 18.0 | 18.0 | 10.0 |
| PB1 | 4.0 | 4.0 | 0 |
| TAED | 3.0 | 3.0 | 1.0 |
| Photoactivated bleach | 0.02 | 0.02 | 0.02 |
| XET | 0.1 | 1 | 3 |
| Polysaccharide | 5 | — | 5 |
| Oligosaccharide | — | 7 | 0.5 |
| Protease | 0.01 | 0.01 | 0.01 |
| Lipase | 0.009 | 0.009 | — |
| Amylase | 0.002 | — | 0.001 |
| Dry mixed sodium sulfate | 3.0 | 3.0 | 5.0 |
| Balance (Moisture & | 100.0 | 100.0 | 100.0 |
| Miscellaneous) | | | |
| Density (g/litre) | 630 | 670 | 670 |

### EXAMPLE XVI

The following nil bleach-containing detergent formulations of particular use in the washing of colored clothing, according to the present invention are prepared:

| | XVIa | XVIb | XVIc |
|---|---|---|---|
| Blown Powder | | | |
| Zeolite A | 15.0 | 15.0 | — |
| Sodium sulfate | 0.0 | 5.0 | — |
| LAS | 3.0 | 3.0 | — |
| DETPMP | 0.4 | 0.5 | — |
| CMC | 0.4 | 0.4 | — |
| MA/AA | 4.0 | 4.0 | — |
| Agglomerates | | | |
| C45AS | — | — | 11.0 |
| LAS | 6.0 | 5.0 | — |
| TAS | 3.0 | 2.0 | — |
| Silicate | 4.0 | 4.0 | — |
| Zeolite A | 10.0 | 15.0 | 13.0 |
| CMC | — | — | 0.5 |
| MA/AA | — | — | 2.0 |
| Carbonate | 9.0 | 7.0 | 7.0 |
| Spray On | | | |
| Perfume | 0.3 | 0.3 | 0.5 |
| C45E7 | 4.0 | 4.0 | 4.0 |
| C25E3 | 2.0 | 2.0 | 2.0 |
| Dry additives | | | |
| MA/AA | — | — | 3.0 |
| NaSKS-6 | — | — | 12.0 |
| Citrate | 10.0 | — | 8.0 |
| Bicarbonate | 7.0 | 3.0 | 5.0 |
| Carbonate | 8.0 | 5.0 | 7.0 |
| PVPVI/PVNO | 0.5 | 0.5 | 0.5 |
| XET | 0.5 | 1 | 0.003 |
| Polysaccharide | 1 | — | 5 |
| Oligosaccharide | — | 2 | 3 |
| Protease | 0.026 | 0.016 | 0.047 |
| Lipase | 0.009 | — | 0.009 |
| Amylase | 0.005 | 0.005 | — |
| Cellulase | 0.006 | 0.006 | — |
| Silicone antifoam | 5.0 | 5.0 | 5.0 |
| Dry additives | | | |
| Sodium sulfate | 0.0 | 9.0 | 0.0 |
| Balance (Moisture and | 100.0 | 100.0 | 100.0 |
| Miscellaneous) | | | |
| Density (g/litre) | 700 | 700 | 700 |

### EXAMPLE XVII

The following liquid detergent formulations, according to the present invention are prepared:

| | XVII | XVII | XVII | XVII | XVII | XVII | XVII | XVII |
|---|---|---|---|---|---|---|---|---|
| | a | b | c | d | e | f | g | h |
| LAS | 10.0 | 13.0 | 9.0 | — | 25.0 | — | — | — |
| C25AS | 4.0 | 1.0 | 2.0 | 10.0 | — | 13.0 | 18.0 | 15.0 |
| C25E3S | 1.0 | — | — | 3.0 | — | 2.0 | 2.0 | 4.0 |
| C25E7 | 6.0 | 8.0 | 13.0 | 2.5 | — | — | 4.0 | 4.0 |
| TFAA | — | — | — | 4.5 | — | 6.0 | 8.0 | 8.0 |
| QAS | — | — | — | — | 3.0 | 1.0 | — | — |
| TPKFA | 2.0 | — | 13.0 | 2.0 | — | 15.0 | 7.0 | 7.0 |
| Rapeseed fatty | — | — | — | 5.0 | — | — | 4.0 | 4.0 |
| acids | | | | | | | | |
| Citric | 2.0 | 3.0 | 1.0 | 1.5 | 1.0 | 1.0 | 1.0 | 1.0 |
| Dodecenyl/ | 12.0 | 10.0 | — | — | 15.0 | — | — | — |
| tetradecenyl | | | | | | | | |
| succinic acid | | | | | | | | |
| Oleic acid | 4.0 | 2.0 | 1.0 | — | 1.0 | — | — | — |
| Ethanol | 4.0 | 4.0 | 7.0 | 2.0 | 7.0 | 2.0 | 3.0 | 2.0 |
| 1,2 Propanediol | 4.0 | 4.0 | 2.0 | 7.0 | 6.0 | 8.0 | 10.0 | 13.- |
| Mono Ethanol | — | — | — | 5.0 | — | — | 9.0 | 9.0 |
| Amine | | | | | | | | |
| Tri Ethanol | — | — | 8 | — | — | — | — | — |
| Amine | | | | | | | | |
| NaOH (pH) | 8.0 | 8.0 | 7.6 | 7.7 | 8.0 | 7.5 | 8.0 | 8.2 |
| Ethoxylated | 0.5 | — | 0.5 | 0.2 | — | — | 0.4 | 0.3 |
| tetraethylene | | | | | | | | |
| pentamine | | | | | | | | |
| DETPMP | 1.0 | 1.0 | 0.5 | 1.0 | 2.0 | 1.2 | 1.0 | — |
| SRP 2 | 0.3 | — | 0.3 | 0.1 | — | — | 0.2 | 0.1 |
| PVNO | — | — | — | — | — | — | — | 0.10 |
| XET | 1 | 0.5 | 0.008 | 2 | 4 | 0.4 | 0.05 | 1 |
| Polysaccharide | 3 | — | 0.8 | — | 2 | — | 10 | 7 |
| Oligo- | — | 10 | — | 3 | — | 15 | 2 | 5 |
| saccharide | | | | | | | | |
| Protease | .005 | .005 | .004 | .003 | 0.08 | .005 | .003 | .006 |
| Lipase | — | .002 | — | .0002 | — | — | .003 | .003 |
| Amylase | .002 | — | — | .004 | .002 | .008 | .005 | .005 |
| Cellulase | — | — | — | .0001 | — | — | .0004 | .0004 |
| Boric acid | 0.1 | 0.2 | — | 2.0 | 1.0 | 1.5 | 2.5 | 2.5 |
| Na formate | — | — | 1.0 | — | — | — | — | — |
| Ca chloride | — | 0.015 | — | 0.01 | — | — | — | — |
| Bentonite clay | — | — | — | — | 4.0 | 4.0 | — | — |
| Suspending | — | — | — | — | 0.6 | 0.3 | — | — |
| clay SD3 | | | | | | | | |
| Balance | 100 | 100 | 100 | 100 | 100 | 100 | 100 | 100 |
| Moisture | | | | | | | | |
| and | | | | | | | | |
| Miscellaneous | | | | | | | | |

The compositions of the present invention can be suitably prepared by any process chosen by the formulator, non-limiting examples of which are described in U.S. Pat. No. 5,691,297 Nassano et al., issued Nov. 11, 1997; U.S. Pat. No. 5,574,005 Welch et al., issued Nov. 12, 1996; U.S. Pat. No. 5,569,645 Dinniwell et al., issued Oct. 29, 1996; U.S. Pat. No. 5,565,422 Del Greco et al., issued Oct. 15, 1996; U.S. Pat. No. 5,516,448 Capeci et al., issued May 14, 1996; U.S. Pat. No. 5,489,392 Capeci et al., issued Feb. 6, 1996; U.S. Pat. No. 5,486,303 Capeci et al., issued Jan. 23, 1996 all of which are incorporated herein by reference.

In addition to the above examples, the cotyledon extracts of the present invention can be formulated into any suitable laundry detergent composition, non-limiting examples of which are described in U.S. Pat. No. 5,679,630 Baeck et al., issued Oct. 21, 1997; U.S. Pat. No. 5,565,145 Watson et al., issued Oct. 15, 1996; U.S. Pat. No. 5,478,489 Fredj et al., issued Dec. 26, 1995; U.S. Pat. No. 5,470,507 Fredj et al., issued Nov. 28, 1995; U.S. Pat. No. 5,466,802 Panandiker et al., issued Nov. 14, 1995; U.S. Pat. No. 5,460,752 Fredj et al., issued Oct. 24, 1995; U.S. Pat. No. 5,458,810 Fredj et al., issued Oct. 17, 1995; U.S. Pat. No. 5,458,809 Fredj et al., issued Oct. 17, 1995; U.S. Pat. No. 5,288,431 Huber et al., issued Feb. 22, 1994 all of which are incorporated herein by reference.

Having described the invention in detail with reference to preferred embodiments and the examples, it will be clear to those skilled in the art that various changes and modifications may be made without departing from the scope of the invention and the invention is not to be considered limited to what is described in the specification.

What is claimed is:

1. A laundry detergent and/or fabric care composition comprising a combination of a xyloglucan endotransglycosylase (XET) enzyme and a polysaccharide and/or oligosaccharide.

2. The composition according to claim 1 wherein said composition comprises a combination of a XET enzyme and a polysaccharide wherein the polysaccharide is a xyloglucan polymer.

3. The composition according to claim 2 wherein said xyloglucan polymer is obtained from tamarind seed polysaccharides.

4. The composition according to claim 2 wherein said xyloglucan polymer has a molecular weight in the range of from about 10,000 to about 1,000,000.

5. The composition according to claim 4 wherein said xyloglucan polymer has a molecular weight in the range of from about 50,000 to about 200,000.

6. The composition according to claim 1 wherein said XET enzyme is obtained from cotyledons.

7. The composition according to claim 1 wherein said XET enzyme is obtained from microorganisms.

8. The composition according to claim 1 wherein said composition further comprises a bleaching agent.

9. The composition according to claim 1 wherein said composition further comprises a cellulase.

10. The composition according to claim 1 wherein said composition further comprises one or more ingredients selected from the group consisting of: surfactants, builders, bleaching agents, dye transfer inhibiting agents, chelants, dispersants, polysaccharides, softening agents, suds suppressors, carriers, enzymes, enzyme stabilizing systems, polyacids, soil removal agents, anti-redeposition agents, hydrotropes, opacifiers, antioxidants, bactericides, dyes, perfumes, brighteners and mixtures thereof.

11. A method for treating a fabric in need of treatment comprising contacting said fabric with an effective amount of a laundry and/or fabric care composition comprising a combination of a xyloglucan endotransglycosylase (XET) enzyme and a polysaccharide and/or oligosaccharide such that said composition treats said fabric.

12. The method according to claim 11 wherein said fabric is selected from the group consisting of cotton, rayon, ramie, jute, flax, linen, polynosic-fibers, Lyocell, poly/cotton, other cotton blends and mixtures thereof.

13. The method according to claim 11 wherein said fabric is treated such that said fabric is imparted one or more of the following properties: anti-wrinkle, shape retention, anti-shrinkage, tensile strength, color appearance, anti-bobbling, static control, fabric softness, and/or anti-wear properties.

14. The method according to claim 11 wherein said method further includes the steps of:
(a) depositing said fabric into a washing machine; and
(b) depositing said effective amount of a laundry and/or fabric care composition comprising a combination of a XET enzyme and a polysaccharide and/or oligosaccharide into said washing machine;
wherein said steps (a) and (b) precede the step of contacting said fabric with said composition.

15. The method according to claim 14 wherein said method further includes the step of:
(c) operating said washing machine in its wash cycle for an effective amount of time such that said composition treats said fabric.

16. The method according to claim 11 wherein said method further includes the step of soaking said fabric in an aqueous solution containing said effective amount of said laundry and/or fabric care composition comprising a combination of a XET enzyme and a polysaccharide and/or oligosaccharide.

17. The method according to claim 16 wherein said method further includes the step of manually washing said fabric for an effective amount of time such that said laundry and/or fabric care composition comprising a combination of a XET enzyme and a polysaccharide and/or oligosaccharide further treats said fabric.

18. The method according to claim 11 wherein said laundry and/or fabric care composition comprising a combination of a XET enzyme and a polysaccharide and/or oligosaccharide further includes a bleaching agent.

19. The method according to claim 11 wherein said laundry and/or fabric care composition comprising a combination of a XET enzyme and a polysaccharide and/or oligosaccharide further includes a cellulase.

20. The method according to claim 11 wherein said laundry and/or fabric care composition comprising a combination of a XET enzyme and a polysaccharide and/or oligosaccharide further includes one or more ingredients selected from the group consisting of surfactants, builders, bleaching agents, dye transfer inhibiting agents, chelants, dispersants, polysaccharides, softening agents, suds suppressors, carriers, enzymes, enzyme stabilizing systems, polyacids, soil removal agents, anti-redeposition agents, hydrotropes, opacifiers, antioxidants, bactericides, dyes, perfumes, brighteners and mixtures thereof.

21. The method according to claim 11 wherein said laundry and/or fabric care composition comprising a combination of a XET enzyme and a polysaccharide and/or oligosaccharide is applied to said fabric by a spray dispenser.

22. The method according to claim 11 wherein said XET enzyme is obtained from cotyledons.

23. The method according to claim 11 wherein said XET enzyme is obtained from microorganisms.

24. A treated fabric made by the method according to claim 11.
